(19) United States
(12) Patent Application Publication
(10) Pub. No.: US 2005/0182607 A1
(43) Pub. Date: Aug. 18, 2005

(54) Process for modeling photons and everything else

(76) Inventor: John R. Ross, Del Mar, CA (US)

Correspondence Address: JOHN R. ROSS, PO BOX 2138, DEL MAR, CA, 92014, US

(21) Appl. No.: 11/108,938

(22) Filed: Apr. 18, 2005

Related U.S. Application Data
(63) Continuation-in-part of application No. 10/655,817, filed on Sep. 5, 2003.
(63) Continuation-in-part of application No. 10/436,286, filed on May 12, 2003, now abandoned.
(63) Continuation-in-part of application No. 10/251,577, filed on Sep. 21, 2002.
(63) Continuation-in-part of application No. 09/908,297, filed on Jul. 17, 2001, now abandoned.
Application No. 10/655,817 is a continuation-in-part of application No. 10/161,823, filed on Jun. 3, 2002.
(60) Provisional application No. 60/562,872, filed on Apr. 16, 2004.

(51) Int. Cl. G06F 17/10

(52) U.S. Cl. 703/2

(57) ABSTRACT

Processes for describing and explaining all elements of the universe including photons, electrons, protons, neutrons, atomic nuclei, heat, temperature, magnetism and gravity. According to this model, the entire universe and everything in it from photons to electrons to protons to galaxies is comprised of nothing but a single type of elementary charged point particle. I call these “pointicles”, “tronnies”. A tronnie has no mass and no volume but it has a charge equal to +e or −e (i.e., about +1.6×10⁻¹⁹ coulomb or about −1.6×10⁻¹⁹ coulomb). Also, according to this model the only forces in the universe are Coulomb forces produced by these tronnies. Every tronnie possesses a Coulomb force field resulting from its charge that travels out spherically from the tronnie's position at the speed of light. Each tronnie is repelled by the force fields of tronnies with like charges and attracted by the force fields of tronnies with opposite charges. Tronnies tend to pair up with a plus tronnie and a minus tronnie in relatively stable configurations that I call “entrons”. It is comprised of one plus tronnie and one minus tronnie with each tronnie of the entron traveling in circles faster than the speed of light (typically πc/2, in the entron's reference frame). An entron is the basic energy quantum in the universe. Entrons may be intergral parts of particles such as protons, atoms, molecules and high-energy electrons. Entrons trapped in matter represent the matter's heat energy. The circling tronnies provide the energy of the photon, hc/λ, where h is Planck's constant and λ is the photon's wavelength which is related to the entron's diameter, d′, by λ=320d′. In my preferred photon model each photon is comprised of one entron that orbits in a circle of diameter λ/2 at 1.57c in the photon's reference frame, with the photon (and its reference frame) traveling forward at a speed of c.

This application is a Continuation-in-Part Application of Ser. No. 10/655,817 filed Sep. 5, 2003, Ser. No. 10/436,286 filed May 12, 2003, Ser. No. 10/251,577 filed. Sep. 21, 2002 and Ser. No. 09/908,297, filed Jul. 17, 2001, which was a Continuation-in-Part of Ser. No. 10/161,823 filed Jun. 3, 2002, now abandoned, all of which are incorporated herein by reference. This application also claims the benefit of Provisional Application No. 60/562,872 filed Apr. 16, 2004. The present invention relates to processes for analyzing nature and in particular for making and supporting models for analyzing photons and everything else the universe.

### BACKGROUND OF THE INVENTION

### Search for the Truth

Since the beginning of human civilization mankind has searched for explanations of the origin of the universe and how it works. Early explanations involved supernatural beings and religions evolved from these efforts. More recent explanations have involved complicated mathematical explanations based on experimental evidence, some involving multiple extra dimensions. Even though humans and their predecessors have been looking at them since creatures began evolving on earth, no one knows the makeup of a photon. Many millions of dollars are being spent in the United States alone and similar efforts are underway in other countries in search of an ultimate theory or explanation that fully explains all of nature.

### Forces and Elementary Particles

Popular theories include several complicated elementary particles that are supposed to be building blocks of matter. These include electrons (positive and negative) and quarks (three of which make a proton and three of which make a neutron). Neutrinos that are produced in abundance in the sun and are so small that most of them that illuminate the earth pass right through it. Popular theories also include a complicated set of forces. These include electromagnetic forces, the “strong” force holding atomic nuclei together, a “weak” force and the force of gravity.

### Photon Speed

In 1878 A. A. Michael and E. W. Morley measured the speed of light in the direction of the earth's travel through the universe in the opposite direction and in other directions. They determined with great accuracy that the measured speed was constant in every direction even though it was known that the earth on which the measurements were made was traveling through the universe at speeds of at least 30,000 meters per second, (about 0.01 percent of the speed of light. This result surprised scientists at that time because they expected that light traveled at a constant speed through an ether so that if the earth was approaching a light beam through the ether, the measured speed should be the sum of the earth's speed plus the constant speed of light. And if the earth were traveling away from the light beam the measured speed of the beam should have been the difference between the light speed and earth's speed. Albert Einstein in 1905 developed his Special Relativity Theory based on this “constant” speed of light. This theory greatly complicated physics since a constant light speed meant other things must change in weird ways. Time must slow down and distances become shorter in a fast moving space ship, simultaneous events in a first frame of reference are not simultaneous in a second frame moving relative to the first. A twin astronaut returning to earth after a space journey would discover that his twin brother who stayed behind would be much older than the astronaut.

### General Relativity and String Theory

Einstein's special theory did not deal with acceleration and gravity but his General Theory of Relativity did. His general theory, attempting to explain gravity further complicated physics proposing for example that gravity produces a curvature of space. Various String Theories also attempt to explain how the universe functions. Relatively very few people understand Einstein's General Theory of Relativity or these string theories. I am one of the many who do not. Most people are reluctant to say these prior art theories are wrong. Not me.

### Need for a Simpler Theory of Everything

Stephen Hawkins in his book, The Theory of Everything, complained that science had become too complicated for philosophers and that they had ceased asking questions such as “Did the universe have a beginning?” and he concluded his text as follows: “However, if we discover a complete theory, it should in time be understandable in broad principal by everyone, not just a few scientists. Then we shall all be able to take part in the discussion of why the universe exists. If we find the answer to that, it would be the ultimate triumph of human reason. For then we would know the mind of God.”

What is needed is a process for modeling photons and everything else in the universe.

### SUMMARY OF THE INVENTION

### Ross Model of the Universe

I have proposed what I believe is the simplest yet model of the universe. I call my model the “The Ross Model of the Universe”. Processes described and claimed herein can be used to describe and explain all elements of the universe including photons, electrons, protons, neutrons, atomic nuclei, heat, temperature, magnetism and gravity. A preferred embodiment of the invention is a model described below.

### Tronnies, Entrons and Photons

According to this model, the entire universe and everything in it, from photons to electrons to protons to galaxies, is comprised of nothing but a single type of elementary charged point particle. I call these point particles “tronnies”. These tronnies also carry the Coulomb force that is the only force in the universe. A tronnie has no mass and no volume but it has a charge equal to plus e or minus e. Also, according to this model the only forces in the universe are Coulomb forces produced by these tronnies. Each tronnie is repelled by the force fields of tronnies with like charges and attracted by the force fields of tronnies with opposite charges. Tronnies repel themselves so they never travel more slowly than the speed of light. Tronnies tend to pair up with a plus tronnie and a minus tronnie in relatively stable configurations that I call “entrons”. An entron is a new is a new addition to the Ross Model. It is comprised of one plus tronnie and one minus tronnie with each tronnie of the entron traveling in circles faster than the speed of light (typically πc/2, in the entron's reference frame). An entron is the basic energy quantum in the universe. Entrons may be intergral parts of particles such as protons, atoms, molecules and high-energy electrons. Entrons trapped in matter represent the matter's heat energy. Entrons released from matter continue to circle with the same frequency as when it was trapped; however it also speeds off at the speed of light. It cannot however travel in a straight line. To do so while circling at 1.57c would require it to go slower than the speed of light during part of each cycle. As a consequence it travels in circles with diameters 160 time larger than its own circle and this double circling configuration does travel in a straight line at the speed of light. It is a photon. The circling tronnies provide the energy of the photon, hc/λ, where h is Planck's constant and λ is the photon's wavelength which is related to the entron's diameter, d′, by λ=320d′. In my preferred photon model each photon is comprised of one entron that orbits in a circle of diameter λ/2 at 1.57c in the photon's reference frame, with the photon (and its reference frame) traveling forward at a speed of c. The result is that the entron oscillates with a frequency of 160 times the frequency of the photon that the entron inhabits.

### Neutrinos and Gravity

Neutrinos are very high-energy photons. Each neutrino comprises a high-energy, high frequency entron. Neutrinos, like other photons, travel in substantially straight lines at the speed of light with its entron circling within the photon in circles having a diameter of λ/2 where λ is the neutrino's wavelength. Most neutrinos illuminating the earth pass right through it. Neutrinos can pass right through the nuclei of atoms and even protons. Gravity results from the Coulomb force fields emanating from neutrinos as the neutrinos pass at the speed of light through matter. These Coulomb force fields travel rearward and sideways along the trail of neutrinos. The sideways components cancel, but the rearward components add pushing the matter through which they are passing back toward the source of the neutrinos. Thus, neutrinos from the sun passing through the earth (about 100,000,000 per square centimeter per second) provide the “gravity” holding the earth in its orbit around the sun. Neutrinos from the black hole in the center of the Milky Way hold all the stars of the Milky Way (including our sun) and us in our positions in our galaxy. Neutrinos captured in the earth and later released provide the earth its gravity.

### Electrons

Three entrons (together comprised of a total of three plus tronnies and three minus tronnies), one of the entrons being a part of a high-energy photon and having a diameter smaller than 3.2×10⁻¹⁵ m, combine in pair production to produce a pair of electrons (a negatron and a positron). The negatron is comprised of a plus tronnie orbiting in a tight circle of radius r at a speed of 1.57 times the speed of light with two minus tronies orbiting around the circular path of the plus tronnie, also at radius r, one-fourth period behind the plus tronnie. The positron is comprised of a minus tronnie and two plus tronnies with their positions reversed from that of the negatron. Although tronnies have no mass and as such provide no resistance to any applied force, when a tronnie combines with two other tronnies to form an electron, the resulting dynamic combination does provide a resistance to applied forces. This is the creation of “mass” which is substantially stationary “energy”. A plus or minus electrons can capture the entron portion of a photon with the entron circling behind the electron forming an equalateral cone. The entron propels the electron at speeds of about one percent of the speed of light. These captured entrons provide the electons with its “voltage”. Electrons (plus and minus) can capture the entron portions of neutrinos, greatly increasing the electron's mass/energy.

### Protons, Neutrons and Atoms

Three very high-energy electrons (one negatron and two positrons, each having captured the entron part of a neutrino to increase their mass several hundred times) combine to form each proton (with mass 1800 times the rest mass of an electron). A neutron is a proton with an extra negatron with a captured entron propeling it at about one percent of the speed of light. This entron has an energy of 0.74 mev (equivalent to a mass of 0.0023055×10⁻²⁷ kg the mass difference between a neutron and a proton and anelectron). The corresponding diameter of the entron is 5.25×10⁻¹⁵ m. In my preferred model of the neutron the two tronnies circling behind the negatron driving the negatron at speeds of about one percent of the speed of light, also pass through the center of the proton part of the neutron. Inside the nucleus of an atom, such the deuterium nucleus the two tronnies of the entron pass through both protons in the nucleus, holding them together. (The reader should note here, no strong force is needed, just an electron and its captured entron.) So the nucleus of an atom is (according to my preferred model) nothing more than a combination of protons and negatrons (along with a variety of entrons) all in dynamic equilibrium. Some specific configurations are proposed. There is no “strong” force holding the nuclei together. Coulomb forces hold them together. The Coulomb force is the only force in the universe.

### Heat, Temperature and Magnetism

Heat is nothing more than entrons (circling tronnie pairs) trapped in matter. Temperature is a measure of that heat. When entrons escape matter they do so as photons. Magnetism results when plus and minus tronnies travel in large loops (such as through the earth to produce its magnetic field or out one pole and in the other pole or through a bar magnet or through the center of a current carrying coil of wire).

### Light Speed

Photons in a light beam slow down when passing through a Coulombic reference frame (such as a laboratory where light speed is being made) moving opposite the beam. And they speed up when the reference frame is moving in the same direction of the beam. Based on this preferred model, time does not slow down when you go fast and things do not get shorter. Simultaneous events are simultaneous in all reference frames. Time is absolute. When an astronaut returns to earth he and his twin brother can have their next birthday party together at the same time.

### Ross Model Consistent with Other Experimental Results

These are merely examples. This basic model proposed here appears to be consistent with all experimental results relating to particle physics, chemistry, optics, fusion and fission that I have considered. This preferred model can be used to explain radio waves, electric current flow, the thermoelectric effects, and the beginning and end of the universe.

### Evolving Model

I admit that some of my explanations are speculative and I am sure that people more familiar with particular technologies than I can improve on my explanations. When they do I will just modify my model to accommodate the better explanations. As is clearly obvious from a review of the parent patent applications preceding this one, I have already modified my model numerous times since I began developing it about four years ago. The model has gotten simpler with each modification. The primary difference between the model described in this application and the models of the parent applications listed above is the “entron”. The energy of the entron corresponds to the net Coulomb integrated forces acting between the entron's circling tronnies and this energy corresponds to the known photon energy hc/?. The entron also provides electrons with their electric energy (their voltage) which they easily give up as heat in a resister or as photons in a radio tmsmitter.

### Einstein's Two Major Goofs

The other important discovery disclosed in this application is that the vacuum speed of light is not constant, but slows down or speeds up, when passing through a Coulombic reference frame, by an amount equal to the speed of the reference frame. For example if a Coulombic reference frame is moving at a speed of 0.1 c in a direction opposite the direction of a light beam, the light beam will slow down to 0.9 c. If the reference frame is moving at a speed of 0.2 c in the same direction of a light beam passing through it, the light beam will speed up to a speed of 1.2 c. So that someone measuring the speed of light with equipment moving with the reference frame will measure the speed of light as the difference between the (1) the speed of the frame and (2) the speed of light. In both cases the measured speed of light will be constant at c. Einstein's first major goof was to assume that the speed of light was constant based on the results of the Michelson—Morley experiments that showed that the “measured” speed of light is always constant. This discovery makes some of the most complicated features of the Special Theory of Relativity unnecessary. Einstein's second major goof was not to recognize that matter-penetrating photons (neutrinos) are responsible for gravity. My discovery that neutrinos “carry” gravity makes most of the complicated features of General Relativity unnecessary if not wrong. Certainly, masses do not curve space. Space is merely the emptiness between things—you can't curve it. Space is also infinite in all three dimensions and there are only three dimensions: up and down, left and right and forward and backwards. Time is not a forth dimension time is a measurable period between events. Time is absolute and is not affected in the least bit by how fast one is moving.

### BRIEF DESCRIPTION OF THE DRAWINGS

FIG. 1 is a representation of a single tronnie pushed by its own force field. The speed of force field is the speed of light.

FIG. 2 shows the direction of attractive and repulsive forces acting in an entron.

FIGS. 2A, 2B and 2C show the positions of two tronnies making up an entron at three times during one period.

FIG. 2D shows Coulomb force fields at time t=OT as shown in FIG. 2C.

FIG. 2E shows positions, times and directions of Coulomb forces acting in an entron.

FIG. 3A is a drawing of a photon in a frame of reference moving with the photon.

FIG. 3B show a section of the photon describing paths of the entron within the FIG. 3A photon.

FIG. 3C is another representation of a photon viewed from a stationary reference frame.

FIG. 4 is a representation of an electron comprising three tronnies one plus and two minuses in a tripple tron twirl. The view is 30 degrees to plane of the circling plus tronnie. Paths of minus tronnies below the plane of the circling plus tronnie are shown as dots and small dashes.

FIG. 5 is a simple electric circuit.

FIG. 6 is a light emitting diode.

FIG. 7 represents a proton. A negatron 322 pushed by neutrino 322A traverses circular path in one period, T. Two positrons 324 and 326 also pushed by neutrinos 324A and 326A orbit in time T the path of negatron 322 (¼ T behind negatron 322).

FIG. 8 is possible configurations of a neutron. A proton with an extra negatron pushed by a high-energy photon.

FIG. 11A is a suggested model of a deuterium nucleus.

FIG. 11B is a suggested model of a tritium nucleus.

FIG. 11C is a suggested model of a helium 4 nucleus or an alpha particle.

FIGS. 12A through 12E depicts a melting crystal.

FIG. 13A through 13E describes types of magnetism

FIGS. 14A through 14E describes an example of exothermic chemistry.

FIG. 15 describes the thermoelectric effect.

FIG. 16 describes gravity.

### DETAILED DESCRIPTION OF PREFERRED EMBODIMENTS

### The Ross Model of the Universe

### Cast of Characters

In a preferred model of the universe, I have created two completely new terms and several old terms are given new definitions based on the preferred model. Therefore, I begin this detailed description with the following definitions that may be referred back to from time to tine by the reader:

Tronnie A mass-less volume-less point particle (a “pointicle”) having a charge of plus or minus e, where e is the magnitude of the electron charge, 1.6×10⁻¹⁹ coulomb. The tronnie is only elementary particle in the Universe and the Coulomb forces associated with its charge are the only forces in the Universe. Tronnies produce Coulomb force fields that travel out from the tronnies at the speed of light. Unlike tronnies attract each other and like tronnies repel each other. The magnitude of the integrated force produced by a force field continuously intersecting a tronnie is inversely proportional to the distance traveled by the force field and approaches infinity as the distance approaches zero. Individual tronnies repel themselves so tronnies always travel as fast or faster than the speed of light. Tronnies almost always travel in circles in association with one or more tronnies where the forces acting between the tronnies are continuos and integrated.

Entron A combination of a plus tronnie and a minus tronnie with each tronnie traveling at speeds of 1.57c in a circle. This is the basic quantum of energy. An entron is a constituent part of every photon and entrons are the energy of every high-energy electron. Several entrons are constituent parts of each proton and account for almost all of the proton's mass. Additional entrons may also form parts of atoms and molecules. Entrons trapped in matter define its heat and temperature. The diameter of the path of the tronnies within the entron is λ′/2 where λ′=λ/160. Where λ corresponds to the photon wavelength of photon the entron is a part of or the photon the entron would create if it were released as a photon from a particle it is a part of or matter in which it is trapped. The entron energy is hc/=hc/160λ′. The net charge of an entron is zero.

Photon A photon is comprised of one circling entron, with the circling entron itself traveling in a looping path. The looping path is the result of the entron following (1) a circular path at a speed of 1.57c, the diameter of the circle being λ/2 where λ is the photon's wavelength and (2) a straight line path at a speed of c, the speed of light. The net charge of a photon is zero; its energy is the entron energy, hc/λ.

Neutrino A very high energy photon with wavelengths substantially shorter than wavelengths of the most energetic gamma rays. Neutrinos are produced in great abundance in the sun, travel at the speed of light and easily penetrate matter. These neutrinos from the sun illuminate the earth at rates of about 100,000,000 per square centimeter pre second. Most pass through the earth. The tronnies in the neutrino produce Coulomb force fields that travel backward toward the source of the neutrinos producing a force on the matter through which the neutrinos are passing. The force is directed backward toward the source of the neutrinos. This force is the gravitational force. Some neutrinos are trapped in the earth and later released providing the earth with its gravity. Black holes are also a great source of neutrinos released from matter the black hole is digesting. Neutrinos from the black hole in the center of our Milky Way Galaxy provide the gravity to hold our galaxy together.

Electron A combination of three circling tronnies. There are two types of electrons: (1) the negatron with a net charge of −e and (2) the positron with a net charge of +e. In the negatron a plus tronnie travels at a very high frequency (very short period) in a tight circle with two minus tronnies circling the path of the plus tronnie one-forth period behind the plus tronnie. In the positron a minus tronnie travels at a very high frequency (very short period) in a tight circle with two plus tronnies circling the path of the minus tronnie one-forth period behind the minus tronnie. A negatron-positron pair is produced in a process called “pair production” by the combination of the six tronnies from (1) the entron part of a gamma ray photon and (2) two entrons trapped in matter. Electrons can capture entrons that provide the electrons their energy (voltage). Electrons can capture the entron parts of neutrino photons to become very high-energy electrons, with substantial increases in energy-mass.

Proton A combination of three very high-energy electrons, one very high-energy negatron and two very high-energy positrons. Each of the high-energy electrons has captured the entron part of a neutrino photon increasing the electron mass several hundred times so that the mass of the proton is about 1800 times the mass of an electron. Eight plus tronnies and seven minus tronnies (the tronnies from two positrons, one negatron plus three neutrino photons) in the proton give it a net charge of plus 1e. An anti-proton is the anti-particle of the proton.

Neutron One proton plus and negatron driven by a gamma ray entron. The tronnies of the gamma ray entron circle behind the negatron and through the center of the proton driving the negatron around the proton at a speed of about one percent of the speed of light. The neutron has a net charge of zero.

### Tronnies

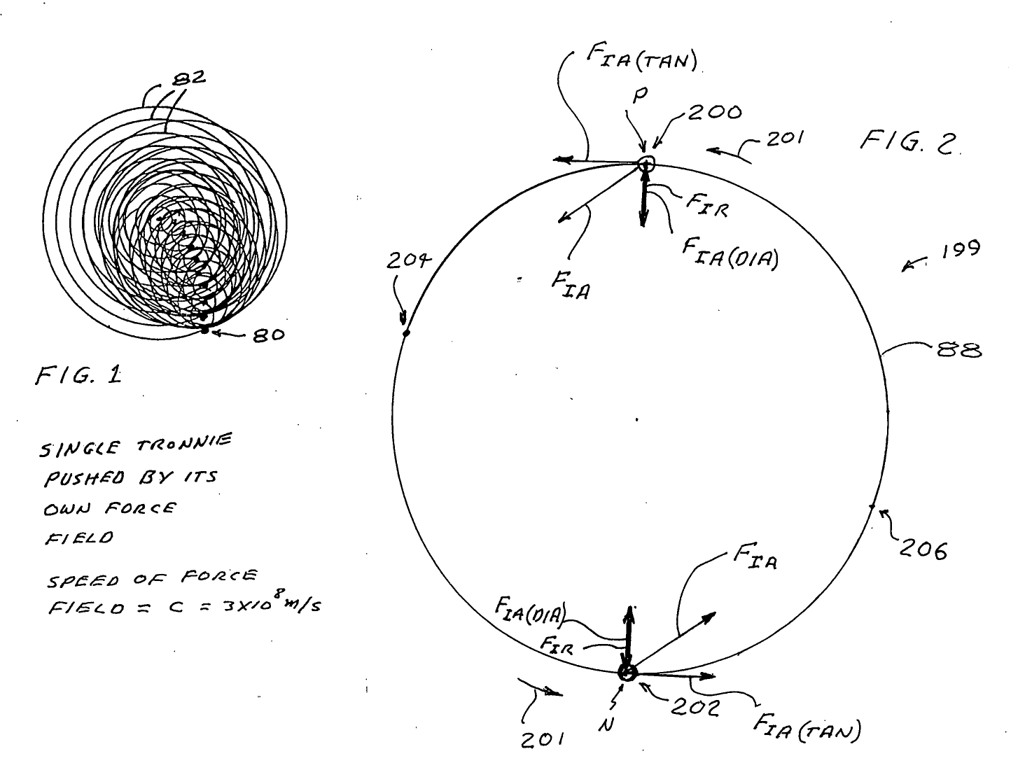

FIG. 1 is a drawing of a single negative tronnie 80. It is a point. It has no mass and no volune, it possesses only a negative charge (−e) and the Coulomb force associated with its negative charge. This Coulomb force is in the form of a force field that proceeds out from the tronnie 80 in spheres 82 expanding at the speed of light. Tronnie 80 is being pushed out by its own Coulomb force fields as shown in FIG. 1. The space between the expanding circles represent a fixed time period such as a nanosecond or a second and a corresponding distance. If the time period is a second, then the distance is 300 million meters! If the time period is one billionth of a second then the distance is about a foot. If the time period is a billionth of a billionth of a second (10⁻¹⁸ second), the distance is atomic size (3×10⁻¹⁰ m). Three of nine circles expanding out from the location of tronnie 80 nine time intervals in the past are shown at 82. Tronnies are very little (infinitely small) and very fast (never slower than the speed of light) and they are usually combined in dynamic equilibrium with at least one other tronnie, which may be why we have lived with them for so long without recognizing them.

If the tronnie is not tied to one or more other tronnies in some sort of association, it may travel through sections of the universe along routes that seem random being pushed and pulled by other Coulomb forces everywhere present in the universe. Since tronnies of opposite sign attract each other, they tend to pair up into configurations (entrons) of circling pairs of opposite tronnies with each tronnie diametrically opposed to its mate.

### Tronnies Are Suggested by Coulomb's Law

Coulomb's Law says that the force between two charges is proportional to the product of the charges and inversely proportional to the square of the distance between them. At distances close to zero, the Coulomb force approaches infinite. A consequence of this law is that elementary charged particles must be point charges with no volume or any other dimension. Otherwise, the elementary charged particle would blow itself apart with infinite or near infinite force. It is obvious that a point cannot have mass. Infinite density makes no sense. Therefore, all charged particles must be charged point particles or be made up of charged point particles. The question is: “Could an elementary charged point particle travel at speeds less than the speed of light.” The answer is “No”. The Coulomb force on a charge A from a like charge A′ is felt by A based on the position of A′ when the force (traveling at the speed of light and reaching A) left A′. Therefore, if a mass-less point charge ever attained a speed equal to or greater than the speed of light, forces from its own past would assure that it never slowed down to a speed of less than the speed of light. I believe no tronnie ever traveled slower than the speed of light but if it did the Coulomb forces from two nearby like charges (each pushing the particle at the speed of light) would drive the mass-less point particle away at speeds greater than the speed of light. Once it is going away from a past position of itself faster than the speed of light its own past (especially its immediate past) will keep it going at at least the speed of light. Therefore, every elementary charged particle in the universe must be a mass-less point particle doomed to always travel at speeds equal to or greater than the speed of light.

### Examples of Things Made form Tronnies

According to preferred embodiments of this invention, everything in the universe is made from tronnies. This application describes and claims processes for describing and explaining elements of the universe based on this model. Thus, all elements of the universe are comprised of only these mass-less, volume-less point particles (we could more properly call them “pointicles”) with their charge of either plus e or minus e. Specific examples of things that are described and explained in this Application by this process include: entrons (a new thing), photons, radio waves, neutrinos, electrons (positrons and negatrons, energetic electrons, electric current, protons and neutrons, atoms, heat and temperature, magnetism, chemical energy, fission and fusion, the thermoelectric effect, gravity, black holes, receding galaxies and the beginning and the end of the universe. The reader should note here that these are merely examples of possible explanations and description for these elements. Persons that are expert in the various fields in which these elements are important can undoubtedly improve on my explanations using the basic model of the universe described above.

Tronnie Pairs—Entrons

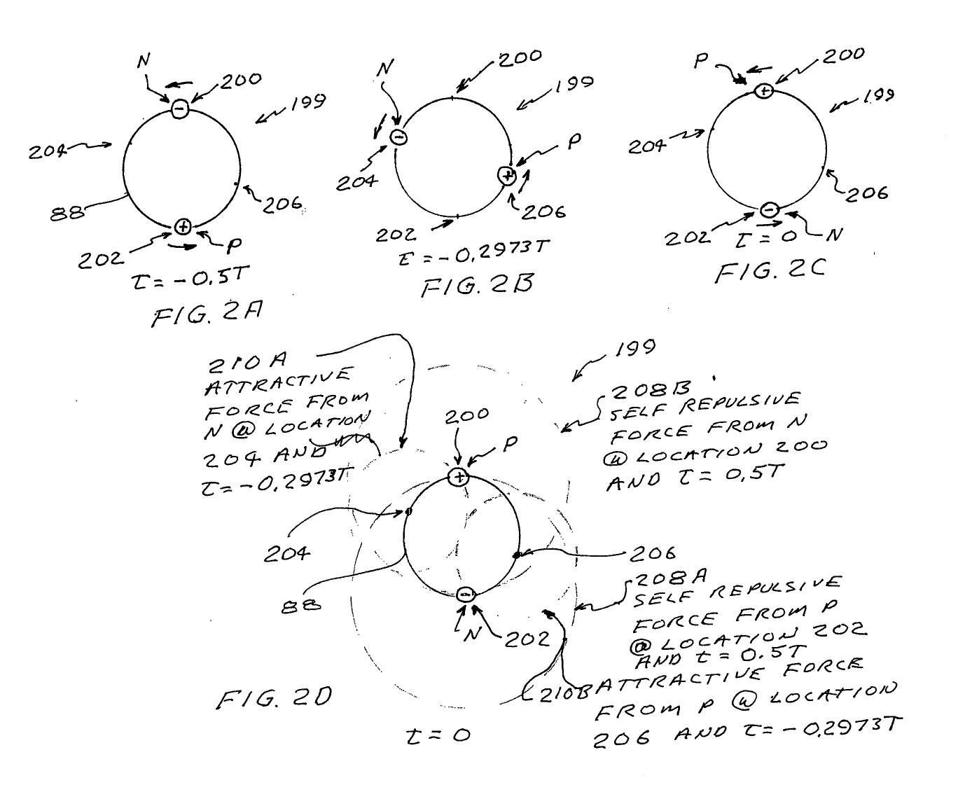

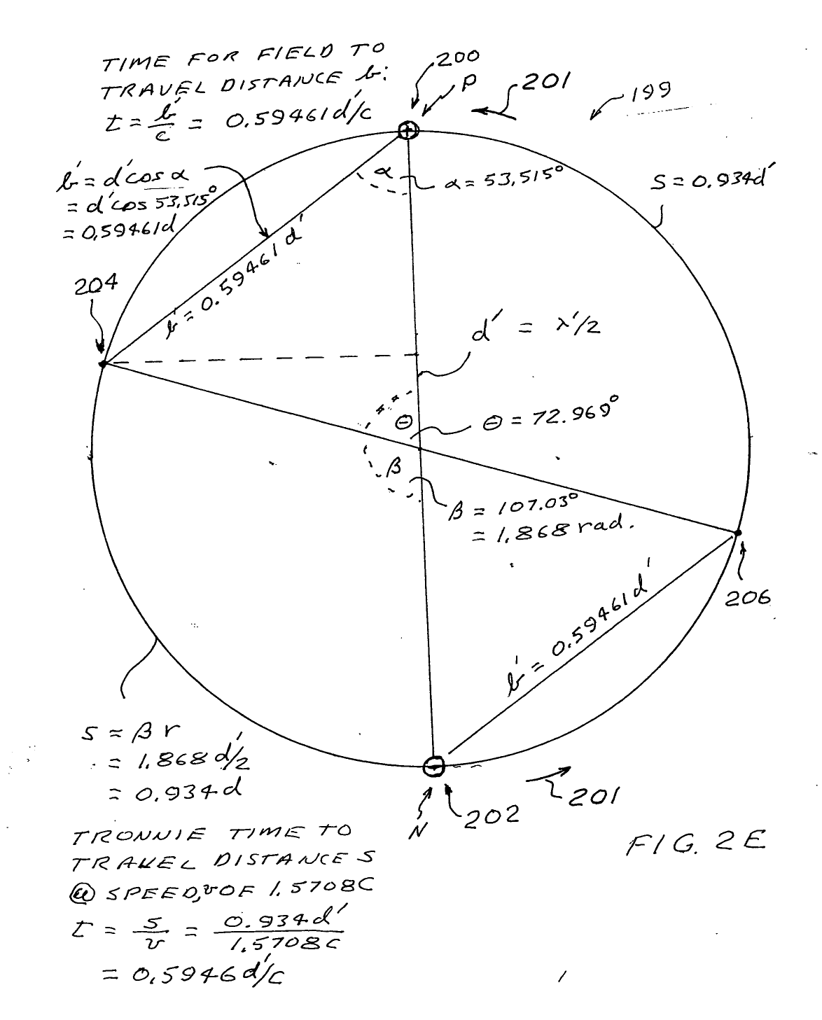

FIG. 2 is a drawing of an “entron” 199. An entron is a circling tronnie pair. In an entron integrated Coulomb forces of a pair of tronnies keep the two tronnies circling in a stable configuration to produce energy and its equivalent mass. A plus tronnie P and a minus tronnie N have joined together in a mutual-attraction—self-repulsion orbit along circular path 88 in direction 201. The diameter of the circle is d′ and this diameter d′ defines a wavelength λ′, as d′=λ′/2, as shown in FIG. 2E. The period of the orbit is T′=1/f′=λ′/c, where f′ is the frequency of the tronnie orbit in entron 199, and c is the speed of light. The wavelength λ′ could be any length. For example if λ′ is 3×10⁻⁹ m (which is the approximate wavelength of an entron λ′ in a green light photon with a photon wavelength λ of 0.48 microns, 4.8×10⁻⁷ m), then T′ would be 1×10⁻¹⁷ second. Plus tronnie P in FIG. 2 is located at the position designated 200 at time, t=0. At time t=−0.5 T′ (t=−0.5×10⁻¹⁷ second) plus tronnie P was located at the position 202 on the opposite side of circle 88. Minus tronnie N is located at position 202 at time, t=0. At time t=−0.5 T′ minus tronnie N was located at the position 200 on the opposite side of circle 88. At time t=about −0.3 T′ plus tronnie P was located at position 206 and minus tronnie N was located at position 204. The forces on tronnies P and N are shown by arrows F_{IA}, F_{IR}, F_{IA(DIA}) and F_{IA(TAN)}. Thus, for this typical green light entron, repulsive and attractive Coulomb forces keep these two tronnies directed around the circle at a frequency of 1×10¹⁷/second (one hundred million billion times per second!). A quantitative discussion of these forces is provided in the following section.

### Calculation of Forces Acting within Entrons

Entron 199 is depicted in FIGS. 2 and 2A through 2E. Three snap shots are shown in FIGS. 2A, 2B and 2C, respectively representing the positions of the two tronnies in entron 199 at t=−0.5 T′, t=−0.2973T′ and t=0, where T′ is one period of oscillation of entron 199. In FIG. 2C the plus tronnie P is shown at location 200 and minus tronnie N is shown at location 202 at t=0. Both tronnies travel around circle 88 at a speed of πc/2 (1.57c=4.71×10⁸ m/s). Their Coulomb forces travel at speeds of c (3×10⁸ m/s), so each tronnie is repelled by it own Coulomb force emanating from itself when it was on the diametrically opposite side of the circle. For example, plus tronnie P at location 200 at t=0 feels the repulsive force emanating from itself at t=−0.5T′ when it was located at location 202 as shown in FIG. 2A. In addition each tronnie is attracted by the other tronnie. For example, plus tronnie P at t=0 feels the attractive force of minus tronnie N emanating from minus tronnie N when minus tronnie N was located at location 204 at t=−0.2973T as shown in FIG. 2B. Likewise, minus tronnie N feels the repulsive Coulomb force that emanated from itself at t=−0.5T′ and the attractive force of plus tronnie P when plus tronnie P was located at position 206 at t=−0.2973T′. The positions of these force fields at t=0 are shown as circles in FIG. 2D. The repulsive force fields are identified as 208A and 208B and the attractive force fields are shown at 210A and 210B. We can calculate these forces. The well-known Coulomb force is:

$$F = \frac{{q}_{1} {q}_{2}}{4 πɛ {d}^{2}} = \frac{2.3 \times {10}^{- 28} {Nm}^{2}}{{d}^{2}}$$

since ¼πε=9.0×10⁹ Nm²/C² and q1 and q2 each equal 1.6×10⁻¹⁹C. The distance separating the charges is d. We integrate this force for one cycle to get the integrated force:

$${F}_{I} = \int \frac{2.3 \times {10}^{- 28} {Nm}^{2}}{{d}^{2}} \\ = 2.3 \times {10}^{- 28} {Nm}^{2} \int \frac{1 dd}{{d}^{2}} = 2.3 \times {10}^{- 28} {Nm}^{2} / ⅆ$$

We eliminated the integration constant by recognizing that forces on the tronnies with very large d (i.e., d=infinity) is zero, so the integration constant is zero.

So now by reference to FIG. 2E, let's look at the integrated forces on plus tronnie P. Let the diameter of the orbit circle be d′ so from equation (2), the repulsive integrated force (FIR) that tronnie P feels at location 200 at t=0 from its own repulsive force field originating on the diametrically opposite side of the circle (i.e., from location 202 at t=−0.5T′) is:
F_{IR}=2.3×10⁻²⁸ Nm²/d (3)
The attractive force from minus tronnie N felt by plus tronnie P depends only on the location of minus tronnie N when the Coulomb force wave which intersects plus tronnie P at time t=0 left minus tronnie N at t=−0.2973T′. I have determined that position to be a point on the circumference of the circle such that angle β as shown in FIG. 2E is 107.03 degrees (1.868 radians). This position is the only position from which the force field 210A could leave minus tronnie N if it is to intersect the path of plus tronnie P at location 200 at the same time as minus tronnie N arrives at location 202.

The time required for minus tronnie N to travel from location 204 to its location 202 at time t=0 at a speed of 1.57c is exactly the same as the time required for its force field 210A (as shown in FIG. 2D) to travel from location 204 to location 200 where it intersects plus tronnie P at time t=0. This is all demonstrated by the following timing calculation:

### Timing Calculation

As shown in FIG. 2E the circumferential path S of minus tronnie N from location 204 to location 202 is:
S=βr=1.868d/2=0.934d (4)
where β (in radians)=1.868 and r=d/2.

Tronnie N travels at a speed of cπ/2 (i.e., 1.5708c) so the time for N to make the journey for 204 to 202 is:
t=s/v=0.934d/1.7708c=0.5946d/c (5)

The distance b that force field 210A must travel from location 204 to intesect plus tronnie P at location 200 is:
b=d cos α=d cos 53.515 degrees=0.5946d (6)

The force field 210A travels at the speed of light c so the time required for the force field 210A to travel from location 204 to location 200 (as shown in FIG. 2D and FIG. 2E is:
t=b/c=0.5946d/c (7)

### Attractive Force Calculation

The distance b from location 204 to location 200 is b=0.5946d; therefore, the attractive integrated force (FIA) from force field 210A on plus tronnie P at location 200 is:
F_{IA}=2.3×10⁻²⁸ Nm²/0.5946d=3.868×10⁻²⁸ Nm²/d (8)

Now this force is directed at an angle α=53.515 degrees, with respect to the repulsive force field produced by force field 208A. So we break the integrated attractive force into two components a diametrical component in the direction of diameter d toward location 202 and a tangential component perpendicular to the diametrical component.

The Diametrical Integrated Force Component

The diametrical component of the attractive integrated force F_{IA(DIA)} is:
F_{IA(DIA)}=F_{IA} cos α=F_{IA} cos 53.515 degrees=2.3×10⁻²⁸ Nm²/d (9)

Comparing the results of Equation (3), the diametrical attractive force F_{IA(DIA)} from field 210A (as shown in FIG. 2D) on plus tronnie P exactly balances the integrated repulsive force FIR from force field 208A (also as shown in FIG. 2D).

The Tangential Integrated Force Component

The tangential component of the attractive integrated force F_{IA(TAN)} is:

$${F}_{1 A ( TAN )} ) = {F}_{IA} sin α = {F}_{1 A} sin 53.515 degrees \\ = ( 3.868 \times {10}^{- 28} ) ( 0.804 ) / d \\ = 3.11 \times {10}^{- 28} Nm2 / d \qquad ( 10 )$$

The tangential component we have just calculated for plus tronnie P is matched by an equal tangential component for minus tronnie N all as shown in FIG. 2. So that the total tangential forces causing entron 199 to spin in the direction shown at 201 is double the value calculated above. Therefore, the integrated net forces F_{IN} operating within entron 199 are tangential and equal to:
F_{IN}=2×F_{IA(TAN)}=6.22×10⁻²⁸ Nm²/d (11)

The units of this parameter are those of energy (i.e., Newton-meters or Joules). So let's call this value of FIN, the integrated forces, the entron energy “Eₑₙₜᵣₒₙ”, so:
Eₑₙₜᵣₒₙ=6.22×10⁻²⁸ Nm²/d. (12)

Now we know that the energy of a Photon is:
Eₚₕₒₜₒₙ=hc/λ

Where h is Planck's constant=6.626×10⁻³⁴ Nms and
c is the speed of light=3×10⁸ m/s, so
   Eₚₕₒₜₒₙ=hc/λ=1.99×10⁻²⁵ Nm²/λ

Now we speculate that the photon energy that we measure (i.e., 1.99×10⁻²⁵ Nm²/λ) is in reality the entron energy (i.e., 6.22×10⁻²⁸ Nm²/d). So we equate the two to determine the diameter of the entron in terms of the wavelength of the photon that it is a part of:
Eₚₕₒₜₒₙ=Eₚₕₒₜₒₙ
6.22×10⁻²⁸ Nm²/d=1.99×10⁻²⁵ Nm²/λ
so the diameter d of the entron is:
d=0.003126λ=λ/320 (13)
where λ is the wavelength of the photon that the entron is a part of.

The time for the Coulomb force fields 208A and 208B (see FIG. 2D) to travel across the entron is t=d/c which is one-half the entron's period, so the entron's period would be:
Tₚₕₒₜₒₙ=2d/c=2λ)/320c=λ/160c=T_{photon/}160 (14)

And the frequency of the entron, fₑₙₜᵣₒₙ is:
fₑₙₜᵣₒₙ=160fₚₕₒₜₒₙ (15)

Let's define a wavelength for the λₑₙₜᵣₒₙ, as twice its diameter so:
λₑₙₜᵣₒₙ=2dₑₙₜᵣₒₙ=λₚₕₒₜₒₙ/160 (16)

To sum up, letting λ, f, T, d and E refer to the wavelength, frequency, period, diameter and energy of photons and λ′, f, T′, d′ and E′ refer to the wavelength, frequency, period, diameter and energy of entrons:
T′=T/160
f′=160f
λ′=λ/160
T′=1/f′
f′=1/T′
λ′=c/f′=2d′
d′=λ′/2=d/160=λ/320
E′=E=hc/λ=hc/160λ′

### Net Integrated Forces Equals Photon Quantum Energy

In summary the energy of an entron in terms of the wavelength of a photon the entron is a part of is equal to the net integrated Coulomb forces of the entron. The diametrical forces cancel leaving only the tangential components of the attractive integrated forces F_{IA(TAN)} as shown in FIG. 2E causing entron 199 to rotate. Those two attractive integrated tangential forces are:
F_{IA(TAN)}=2(2.3×10⁻²⁸ Nm²/b)sin α
F_{IA(TAN)}=2(2.3×10⁻²⁸ Nm²/0.5946d) sin α
F_{IA(TAN)}=2(2.3×10⁻²⁸ Nm/0.5946)(320/λ)0.804
F_{IA(TAN)}=1.99×10⁻²⁵ Nm²/λ (17)

Where distances b and d and angle α are shown in FIGS. 2E and λ is the photon wavelength.

These tangential integrated forces acting within entron 199 to cause its two charges to rotate is equal to the to the well known quantum energy of the photon that the entron is a part of, namely:
E=hc/λ
E=(6.626×10⁻³⁴ Nms)(3×10⁸ m/s)/λ
E=1.99×10⁻²⁵ Nm²/λ (18)
Formation of an Entron

A potential problem with this “tronnie” theory is that if these plus and minus tronnies have opposite charges and no mass, why don't they attract each other, combine and disappear (as do positrons and negatrons)? I believe that tronnies never combine to annihilate each other. The reason is that each tronnie is repelled by itself at speeds equal to or greater than the speed of light. If a tronnie is riding in a straight line on its own Coulomb force wave, the repelling force is infinite, continuous and always greater than any attractive force. Any attractive force from another tronnie cannot be continuous unless the two tronnies are traveling together in some kind of pattern, such as a circle (see FIG. 2D, for example). Two tronnies approaching each other (at the speed of light or greater) merely pass each other and fly off in opposite directions each feels significant attractive force from the other for only an extremely short time interval. However, if billions of tronnies are confined to a small space, unpaired plus and minus tronnies will quickly be forced into circles with diameters of various lengths (see FIGS. 2 and 2A-F). These circling tronnies pair up into entrons. Entrons can leave a space by radiation or conduction. The energy of these entrons in either case is E=hc/λ or (h/160)c/λ′, where h is Planck's constant, λ is the photon's wavelength and λ′ is the entron's wavelength (λ′=λ/160) and c is the speed of light. Once an entron is formed, especially a high-energy entron, it can exist in its condition for billions of years. We can look up and see photons from galaxies billions of light years distant that have been flying through our universe unchanged for that many years.

Photons

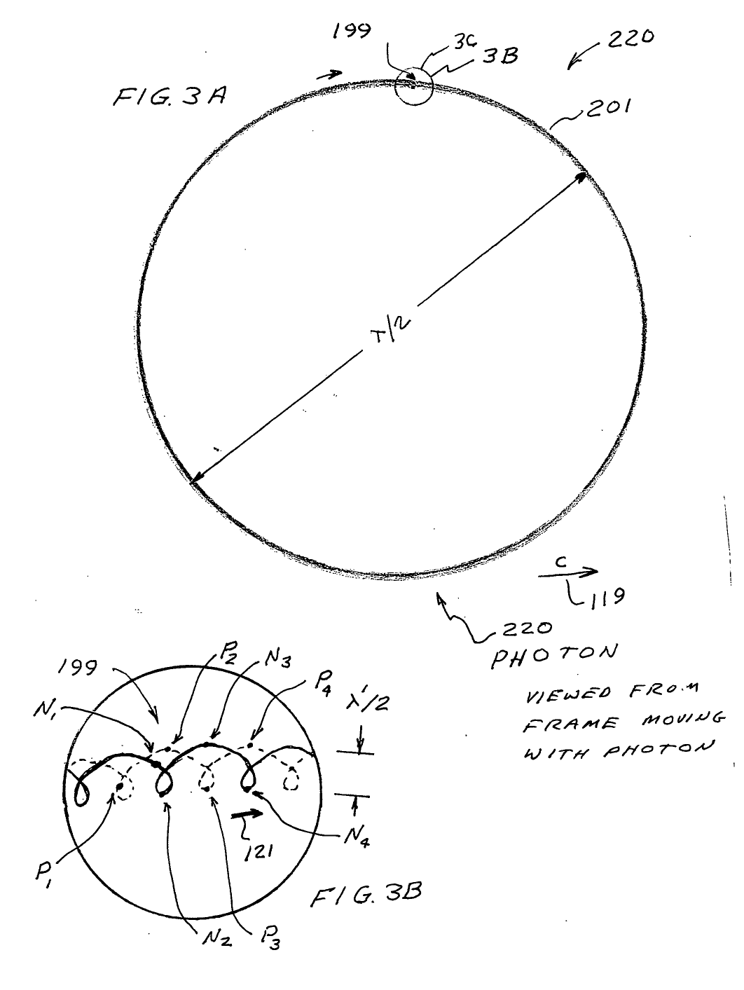

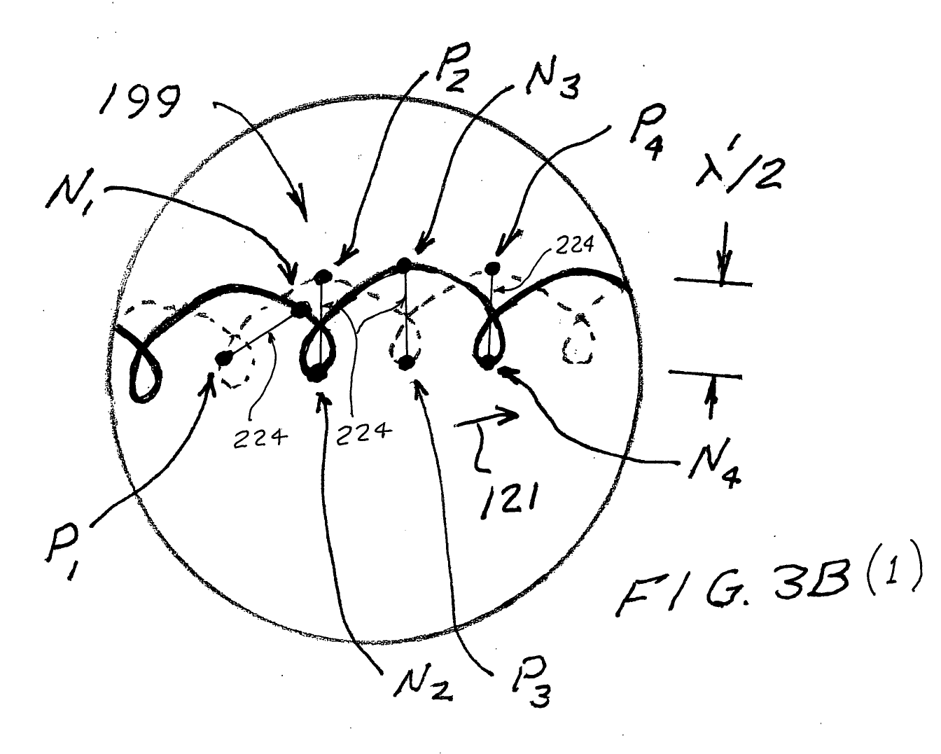

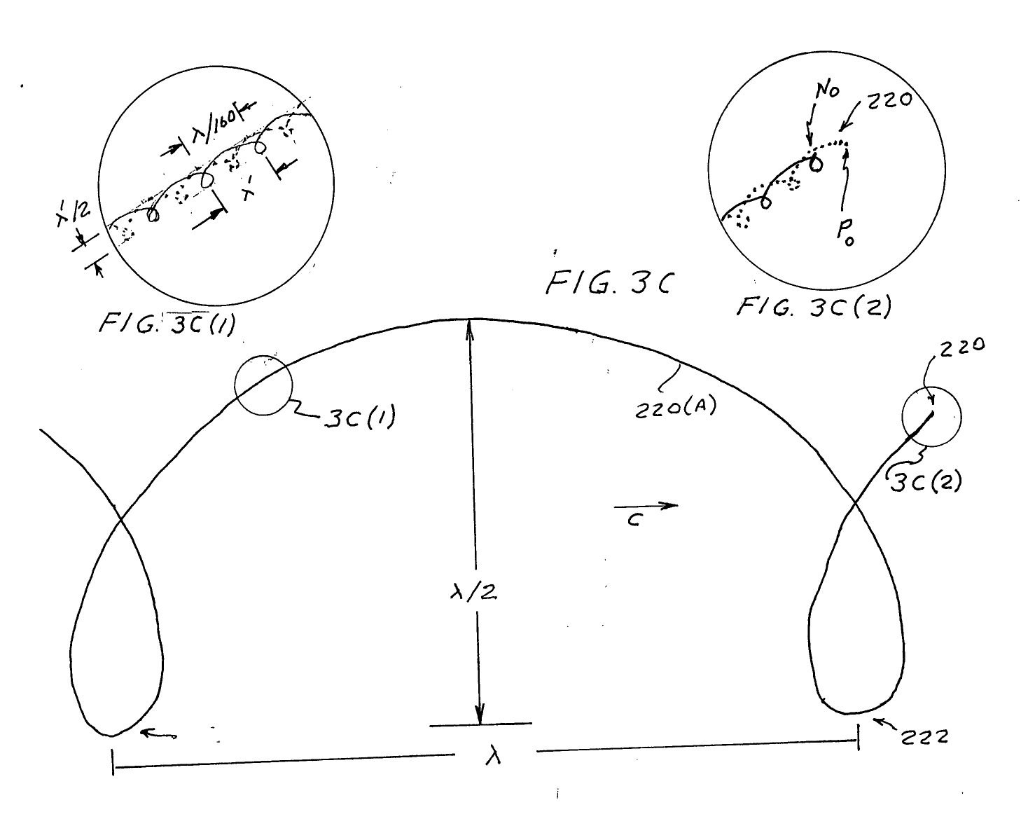

My latest photon model is shown in FIGS. 3A, 3B and 3C. This model is based on my belief that the entron is an integral part of every photon. The two tronnies of the entron in a photon follow an approximately circular path in the reference frame of the entron and the entron (and its reference frame) follows an approximately circular path in the reference frame of the photon (which in our reference frame is moving in a straight line at the speed of light). The diameter of the photon circle is 160 times larger than the diameter of the entron circle (d=160d′ as explained above).

FIG. 3A is a drawing of the photon made in the photon's frame of reference that is moving at the speed of light as indicated by arrow 119. In this frame of reference entron 199 is shown small in FIG. 3A compared to the photon and is shown enlarged in FIG. 3B. (The “size” of the photon is 160 times larger than the entron's “size”. When I refer to size of an entron or a photon, I refer to the diameter of their circles. As shown in FIGS. 3A and 3B, the diameter of the photon circle 201 is λ/2 and the diameter of the entron circle is λ′/2. As explained above, λ is the wavelength of the photon and λ′ is the wavelength of the entron and λ′=λ/160.) Entron 199 as shown in FIG. 3B is comprised of plus tronnie P and minus tronnie N and photon 220 (shown in FIG. 3A) is comprised of entron 199. If you prefer photon 220 is also comprised of plus tronnie P and minus tronnie N which are shown at two spots at 199 in FIG. 3A. (I will digress here for a second to point out again that everything in the universe is comprised on nothing but plus tronnies P's and minus tronnies N's.) Entron 199 is moving in circular path 201 at a speed of 1.57c in the frame of reference of photon 220. The two tronnies making up entron 199 are moving even faster than the entron itself, since they are also moving at speeds of 1.57c in the entron's frame of reference along an approximately circular path as shown in FIG. 2.

Why Entrons Form Themselves into Photons

The reader may ask why entrons, once free from the matter that they had been heating up, don't shoot off at the speed of light in a straight line. The answer, according to this preferred model, is that the entron tries to shoot off at the speed of light in a straight line but is forced into a path of looping circles 160 times larger than the entron circle. (The reader may be able to picture an outboard motor boat on a fast flowing river where the motor is directed at a slight angle with the axis of the boat.) An entron pushing itself through space is forced to travel in looping circles having a diameter of λ′/2 along a curved path as shown in FIG. 3B that that produces another set of looping circles defining a photon as shown in FIG. 3A (photon reference frame) and 3C (stationary reference frame) and having a diameter of λ/2, where λ=160λ′. The small looping circles represent the entron and the large looping circle represents the photon. As explained above an entron's normal configuration is two opposite tronnies traveling at 1.57c on opposite sides of a circle or diameter λ′/2. Its own Coulomb forces can drive the entron (the rotating tronnie combination) away at the speed of light. In FIG. 3B, the two tronnies are circling at 1.57c and traveling in a direction 121 at the speed of c, where the plane of the circle is in the 121 direction. Note that the separation of the two tronnies is always λ′/2 and that at locations where the tronnies are designated N₂, P₃ and N₄, each of the tronnies are traveling in the minus X direction (i.e., backwards). Also, note that for almost the entire path the tronnies are traveling much faster than the speed of light. However for a short period near locations designated N₂, P₃ and N₄ the tronnies along this path would be traveling more slowly than the speed of light, which is impossible. (The actual speed would be the sum of plus c and minus 1.57c that would be minus 0.57c. That is slower than the speed of light. Therefore, I believe the actual path is one in which at positions designated N₂, P₃ and N₄, the tronnies travel backwards at a speed of c instead of 0.57c.) The result is, according to this model, that the path of the entron must be curved. The curvature I am proposing is that which would cause the entron to make a complete loop in 160 cycles of itself as it moves forward in a straight line as a part of its photon. We need confirmation of this concept.

FIG. 3C is a drawing of the path 220(A) of photon 220 by someone watching it pass from a stationary frame of reference. FIG. 3C shows a little more than one wavelength λ of the photon's path. The reader will note the path made by the photon is similar to the path made by a spot on the rim of a wagon wheel rolling across the prairie. However, for the analogy to be perfect the wagon wheel would need to be rotating 1.57 times faster than ordinary wagon wheels; that is, the spot on the rim would need to be moving 1.57 times faster than the wagon. Where the spot meets the prairie, the spot would be traveling in reverse instead of being stationary. The entron makes 160 revolutions during each photon cycle. About four of these entron revolutions are shown in FIGS. 3B and 3B(1) (in the photon's reference frame). FIG. 3B(1) is an enlargement of FIG. 3B and in FIG. 3B(1) I have drawn lines 224 connecting tronnies N and P at the four time periods. For example, one of the lines 224 indicates that when plus tronnie P was at location P3, its partner minus tronnie N was located at location N3. The looping paths of the two tronnies should now be clear to the reader. These revolutions of the tronnies are also shown in FIGS. 3C(1), and 3C(2) seen from a stationary reference frame watching the photon pass by. Note that in this frame of reference the entron itself (made up of the two tronnies) speeds up and slows down (actually traveling backwards at locations 222) during each photon cycle. But there are no forces on the tronnies trying to slow them down to less than the speed of light. Therefore, the photon unlike the entron can travel through the universe in a straight line. Based on this model, the two tronnies making up an entron are always separated from each other by a constant distance, λ′/2.

The Size of Typical Photons and Entrons

This preferred model proposes an entron diameter of λ/320 where λ is the wavelength of the photon that the entron is a part of. And the diameter of the photon is λ/2. So we can visualize the size and energy of some photons we are familiar with. The following table lists some typical photons by their wavelengths energy and diameter.

TABLE I

| | Photon | | Entron-Photon | | Entron | | Photon | |
|---|---|---|---|---|---|---|---|---|
| Photon | Wavelength, λ | | Energy | | Diameter | | Diameter | |
| Near IR Photon | 1 × 10⁻⁵ | m | 0.124 | ev | 3.1 × 10⁻⁸ | m | 0.5 × 10⁻⁵ | m |
| Green Light Photon | 0.54 × 10⁻⁶ | m | 2.29 | ev | 1.7 × 10⁻⁹ | m | 0.27 × 10⁻⁶ | m |
| X-Ray Photon | 1 × 10⁻¹⁰ | m | 12.4 | kev | 3.1 × 10⁻¹³ | m | 0.5 × 10⁻¹⁰ | m |
| Hydrogen Photon | 0.91 × 10⁻⁷ | m | 13.6 | ev | 2.84 × 10⁻¹⁰ | m | 0.455 × 10⁻⁷ | m |
| Gamma Ray Photon | 1.22 × 10⁻¹² | m | 1.02 | mev | 3.8 × 10⁻¹⁵ | m | 0.61 × 10⁻¹² | m |
| Neutrino Photon | 3.97 × 10⁻¹⁵ | m | 312 | mev | 1.2 × 10⁻¹⁷ | m | 1.99 × 10⁻¹⁵ | m |
| Neutron Electron | 16.8 × 10⁻¹³ | m | 0.74 | mev | 5.25 × 10⁻¹⁵ | m | 8.40 × 10⁻¹³ | m |
| Photon | | | | | | | | |

Neutrinos

Scientist tell us that more than 150 million neutrinos mostly from the sun pass through each square centimeter of the earth each second and a very large fraction of that number pass right through the earth. According to this model a neutrino is a very high-energy (short wavelength, shorter than 1×10⁻¹⁴ m) photon. The reader should note that typical charts showing the electromagnetic spectrum show wavelengths between about 1×10⁻¹⁵ m and 1×10⁸ m. Note that 1×10⁻¹⁵ m is about the size of a proton. As described above the diameter of a photon is one half its wavelength and the separation of the tronnies in a photon is its wavelength divided by 320. So the two tronnies in a neutrino with a wavelength of 3.97×10⁻¹⁵ m (corresponding to a photon energy of 312 mev) as indicated in Table I, would be separated by a distance of only 1.2×10⁻¹⁷ m. The distance across a typical atom is about 10 million times larger and the atom is almost entirely empty space. Even the protons in the atoms are about 100 times larger than the separation of the two tronies in a 312 mev neutrino photon. This means that photons with energies in the range of 312 mev and having net zero charge would pass right through most things. The maximum separation between the two tronnies in the neutrino photon (one half its entron's wavelength) is roughly about 25 thousand times smaller than the separation of the tronnies in an X-ray photon. X-rays pass through our bodies. Neutrinos pass through our earth.

Polarization

As indicated in FIGS. 3A, 3B, 3C and 3C(1), the tronnies and the entron are all confined to a single plane as a part of the photon shown in FIG. 3C. This may suggest an explanation for polarization of electromagnetic radiation. If all the photons in a beam are traveling in the same plane, the beam would be polarized. I have not been able to correlate this particular model with all the features I think I know about polarized and un-polarized light. If this model is correct, I believe these correlations should be fairly obvious to optical experts.

Radio Waves

Radio waves may travel as photons as described above. However, it is hard for me to imagine a radio photon that is a mile or more wide, which would be the case for photons in low frequency radio beams. It may be that, low frequency radio waves travel out from antenna as alternating pulses of plus and minus tronnies and generally not as photons. In each pulse the tronnies (all of the same charge) propel themselves spherically outward at the speed of light. As they travel outward each tronnie leaves a trail of Coulomb force which helps pull the oppositely charged tronnies in the immediately following pulse of tronnies. When these pulses of tronnies encounter an antenna they are absorbed by it, charge it with their charge so that the antenna is attractive for the oppositely charged tronnies in the immediately following pulse of tronnies. A properly designed electronic circuit with an oscillator, oscillating in synchronization with the radio transmitter isolates and detects the radio signal imposed on the radio beam. Higher frequency radio waves such as those produced by half-wave antennae probably travel as polarized photons like the one shown in FIG. 3C.

Positrons and Electrons

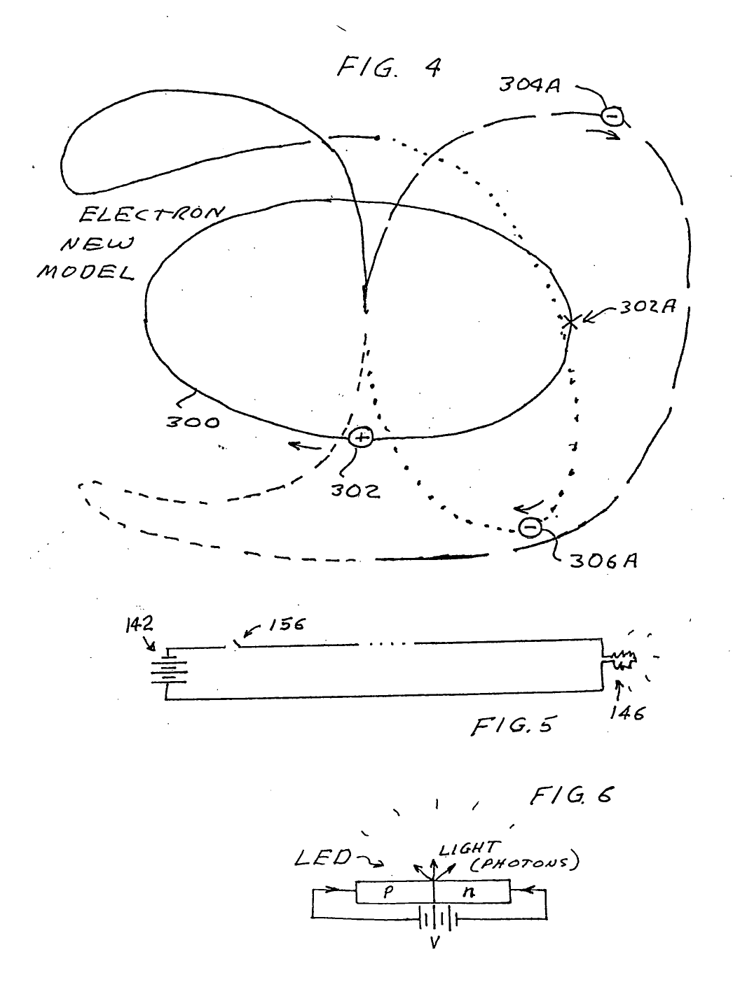

My latest negatron model is shown in FIG. 4. A plus tronnie 302 follows a circular path and two minus tronnies 304A and 306A orbit the path one-fourth period behind the circling plus tronnie. The negatron in this figure is viewed from a position 30 degrees above the plane of the plus tronnie's circular path 300. The path of minus tronnie 304A is shown in long dashes above the plus tronnie's plane and short dashes below the plane. The path of the minus tronnie 306A is shown in solid line above the plane and dots below the plane. FIG. 4 represents a snap shot drawing at a time, t=0. Three arrows show the direction of the three tronnies at the time of the snap shot. The positron is exactly the same as a negatron except the sign of the three tronnies are reversed. The central circling tronnie is a minus tronnie and the two tronnies orbiting the circular path are plus tronnies. The positron and the negatron may be produced in a pair production process as explained above as the result of the marriage of three entrons, one high-energy entron (being the entron of a high-energy gamma ray photon) with the entrons of two lower energy photons trapped in matter. I suspect that the minus tronnie of the high-energy photon can desert its mate, the plus tronnie to form a three part electron only if the plus tronnie finds partners to form a three part positron at the same time. Each of the two tronnies of the high-energy photon becomes one of the tronnies orbiting the path of the central circling tronnie (302 in FIG. 4). I am not certain of the dimensions of the electrons. The dimensions must be non-zero since tronnies 304 and 306 must pass through the center of the path of tronnie 302. (The electron is definitely not a point particle.) The size of the electron initially may depend on the energy of the gamma ray that caused its formation. As indicated in Table I, the diameter of the entron in the lowest energy gamma ray photon that can create electron pairs is 3.2×10⁻¹⁵ m. This is about the size of a proton. The electron must be much smaller since a proton is comprised of three of them. I doubt if the size of the electron and positron are dependent on the energy of the gamma ray that formed it. My understanding is that pair production becomes more probable the shorter the wavelength of the creation gamma. If all electrons (at rest energy) are the same (which is my understanding), there must be an equilibrium electron structure. Once formed the electron probable collapses into a very tight small and stable dynamic structure. The Coulomb forces holding the electron together are tremendous, the tronnie speeds are in excess of the speed of light and, as far as I know, an electron once formed may be indestructible by any known means other than by annihilation with its anti-particle.

Electron with Captured Entrons

An electron (negatron) may capture one or more entrons and thereby increase its energy (mass). Thus, the energy-mass of the electron is determined at least in part by the entron it captures. As the two negative tronnies orbit the path of the circling positive tronnie the three tronnies create fluctuating force fields that are rotating and are attractive for tronnies paired up in entrons provided the frequencies resonate. Once captured tronnies in the entron will exert forces on the electron, propelling the electron. My current preferred model of a high-energy electron is shown in FIG. 4A. The electron is shown at e. It is moving in direction d at about one percent of the speed of light. (I have not figured out the exact speed. I will take a stab at the typical speed of the electron at c/160 as indicated in FIG. 4.) My guess is that high-energy electrons tend to always move at the same speed until their path is blocked as it quickly is when, for example, it is current flowing in a copper wire. Here is my guess at what makes electrons go: The entron 199 is comprised of plus tronnie P and minus tronnie N circulating at a rate f′ with a diameter λ′/2. The three entities are synchronized such that Coulomb forces from electron e attract plus tronnie P and Coulomb forces from tronnie N repel electron e. Minus tronnie N stays out ahead of plus tronnie P by a distance of λ′/320. The whole configuration is moving fast enough that tronnie N does not feel the repulsive force from electron e. Electron e creates a “Coulomb wake” as it speeds along at a speed of c/160. Minus tronnie N is in front of the wake and does not feel a repulse force from electron e. However, plus tronnie is riding on the electron's wake and feels its attractive force continuously as indicated by the arrows pointing toward electron e from P at times t=−0.5T′, t=0 and t=+0.5T′. Electron e on the other hand continuously feel the repulsively force of minus tronnie N as indicated by the arrows from N at t=−T′, t=−0.5T′, t=0 and t=+0.5. Based on this model λ′ can be any value so that the electron can have any energy from a small fraction of an electron volt to many million electron volts. And it can easily give up its energy as heat or as photons.

Electric Current

FIG. 5 shows a very simple electric circuit with 24-volt battery 142 and 24-volt lamp 146 separated by a one-mile copper pair with switch 156 near the battery. When the switch 156 is closed the light begins to glow almost instantly long before electrons could possibly travel the one-mile length of the copper pair. The popular explanation is that electrons near the battery push on other electrons so that an electron-domino effect pushes electrons that had been near the lamp through the lamp filament. The result is that the effective speed of the current in the circuit is a large fraction of the speed of light.

I do not have it yet, but I believe my model will provide the explanation for the speed of electricity through copper wires. The tronnies could certainly travel from one end of the wire to the other at net speeds near the speed of light. (Their instantaneous speed must always be as great or greater than the speed of light.) I believe that it is the entrons that make the trip from one end of the wire to the other. They might jump off a high-voltage electron coming out of the battery and travel to the lamp through the wire and allow themselves to be captured by an electrons near the lamp to increase the energy of the capturing electrons. As the capturing electrons then pass through the filament of the lamp the entrons escape from the capturing electrons and become quanta of heat in the filament. As explained below entrons captured in matter are the heat quanta in the matter and define the temperature. The more captured entrons the greater the heat and the higher the temperature; the higher the energy of the entrons the greater the heat. Entrons captured in matter can share energy with each other to produce an energy distribution. Some of these entrons will escape the filament in the form of photons. If the temperature is high enough some of these photons will be visible light photons.

Voltage and Entrons

I am guessing that entron energy may correlate to electric voltage. Here is how this reasoning goes:

Electrons stored in a 24-volt battery are electrons that have captured an entron with energy of 24 eV, equivalent to 4.16×10⁻¹⁸ J (24 eV×1.6×10⁻¹⁹ J/eV). According to equation 18 the energy of an entron is:
E=1.99×10⁻²⁵ Nm²/λ=(1.99×10⁻²⁵ Nm²/λ)(λ/160 λ′)
E=1.24×10⁻²⁷ Nm²/λ

So on this basis we calculate that wavelength ?′ of the entrons giving energy to the electrons of a 24 V battery is:
λ′=1.24×10⁻²⁷Nm²/4.16×10⁻¹⁸ J
λ′=3×10⁻¹⁰ m

This entron released would create a photon of wavelength:
λ=160×(3×10⁻¹⁰ m)=4.8×10⁻⁸ m.

This is ultra-violet photon. In a high resistance lamp filament this entron would transfer energy to other lower energy entrons trapped in the filament so that some entrons corresponding to visible light photons would be produces and released as visible light photons. A 2-volt entron would correspondingly produce a photon of 570×10⁻⁹ m, which is green light. (My current speculation is that electrons easily transfer their captured entrons to other electrons. And I now believe that each electron desires only one entron at a time. So that if an entron is transferred to an electron that already has a captured entron, the captured entron may be cast off as heat or radiation. Or the two entrons on the electron may change partners to create an entron having a frequency equal to the sum of the frequencies of the original two entrons and another entron with a frequency equal to the difference between the frequencies of the original two entrons.)

Protons and Neutrons

My current preferred proton model 320 is shown in FIG. 7. This proton model is very similar to the positron version of my electron model shown in FIG. 6 except in the place of the minus and the two plus tronnies we have a negatron 322 in the circular loop and the two positrons 324 and 326 orbiting the circular loop. These electrons are being pushed in their paths by trapped high-energy entrons (i.e., the entrons of neutrinos) 322A, 324A and 326A. The frequency of the high-energy entrons is high enough so that the energy/mass of the proton is increased by a factor of about 1800 compared to the energy/mass of an electron. For example, the neutrino photon listed in Table I has energy equal to 312 mev (mass equivalent to 55.6×10⁻²⁷ kg). The 312 mev masses of three of these entrons, 322A, 324A and 326A plus the 0.511 mev rest masses of the negatron and two positrons gives the mass energy of the proton at 939.2 mev (1.67×10⁻²⁷ kg). The reader should note that the size of the neutrinos entrons 322A, 324A and 326A shown in FIG. 9 is about 1.2×10⁻¹⁷ m compared to a proton size of about 1×10⁻¹⁵ m. I recognize that this model of the proton seems somewhat complicated, with one negatron, two positrons and three neutrinos pushing the negatron and the two positrons in their orbits. However, my understanding is that the ultimate products of a proton—anti-proton annihilation are positrons, negatrons and neutrinos. So maybe this model is correct. Each of the three electrons and their associated neutrino have features similar to what some people are calling quarks. (No one has ever seen a quark.) I suspect that the movements of all of these tronnies (in this model there are 15 of them: 7 minus and 8 plus) are precisely synchronized with each other with enormous Coulomb forces holding them dynamically in place. I am looking forward to some smart computer person creating a 3-D computer model corresponding to this model so we can watch all the little tronnies loop around each other in very, very, very slow motion.

The anti-proton is just the opposite of the proton and comprises a positron in the place of negatron 322 in FIG. 7 and two negatrons in the place of positrons 324 and 326. Like the electrons, the proton and the anti-proton are held together by enormous Coulomb forces and are extremely stable except through the process of annihilation with each other.

My latest neutron model is shown in FIG. 8. A neutron shown at 321 is a proton with an extra negatron e with a captured entron propeling it at speed of about c/160. The proton is shown at 320. The circulating electron e is circling on path 321A and its captured entron shown at 321B is pushing the electron around the proton. This entron has an energy of 0.74 mev (equivalent to a mass of 0.0023055×10⁻²⁷ kg which is the mass difference between [1] a neutron and [2] a proton plus an electron). The corresponding diameter of the entron is 5.25×10⁻¹⁵ m. In my preferred model of the neutron, the two tronnies circling behind the negatron (driving the negatron at speeds of about c/160) also pass through the center of the proton part of the neutron as shown in FIG. 8. Inside the nucleus of an atom, such as the deuterium nucleus the two tronnies of the entron pass through both protons in the nucleus, holding them together. (The reader should note here, no strong force is needed, just an electron and its captured entron.) So the nucleus of an atom is (according to my preferred model) nothing more than a combination of protons and negatrons (along with a variety of entrons) all in dynamic equilibrium. Some specific configurations are proposed. There is no “strong” force holding the nuclei together. Coulomb forces hold them together. The Coulomb force is the only force in the universe. Here I caution the reader again that these configuration of nuclei described above are only my best guesses at the present time. They are probably incorrect. My only point is providing them is to show tronnies in the form of electrons, positrons and entrons can be put together to make anything. If my configurations are not the best or most likely 1 believe some other configuration of these things will be.

The Hydrogen Atom

I believe the hydrogen atom is much like my model of the neutron except the entron pushing the electron around the proton is a ultra-violet light entron with an energy of 13.6 ev which means that the entron diameter is about 2.84×10⁻¹⁰ m which is about the size of atoms. As with the neutron this model of the hydrogen atom has the entron circling behind the electron pushing it about c/160 around the proton with both tronnies of the entron passing through the center of the proton on each loop.

Atomic Nuclei

I do not have a precise model of atomic nuclei. For each stable nucleus there may be several possible equilibrium configurations where the constituents of the nuclei are held together with Coulomb forces. In FIG. 9, I show a possible configuration for the deuterium nucleus. The deuterium nucleus according to the prior art is comprised of a proton and a neutron. In my model it is comprised of two protons and an electron circled by a gamma ray entron. In the configuration shown in FIG. 9 the entron passes through the center of each proton.

FIG. 10 is a suggested model of a tritium nucleus. The prior art thinking is that this nucleus is comprised of a proton and two neutrons. In the suggested FIG. 10 model, three protons follow a circular path that is orbited by two electrons, all of the protons and electrons being driven on their paths by high-energy entrons.

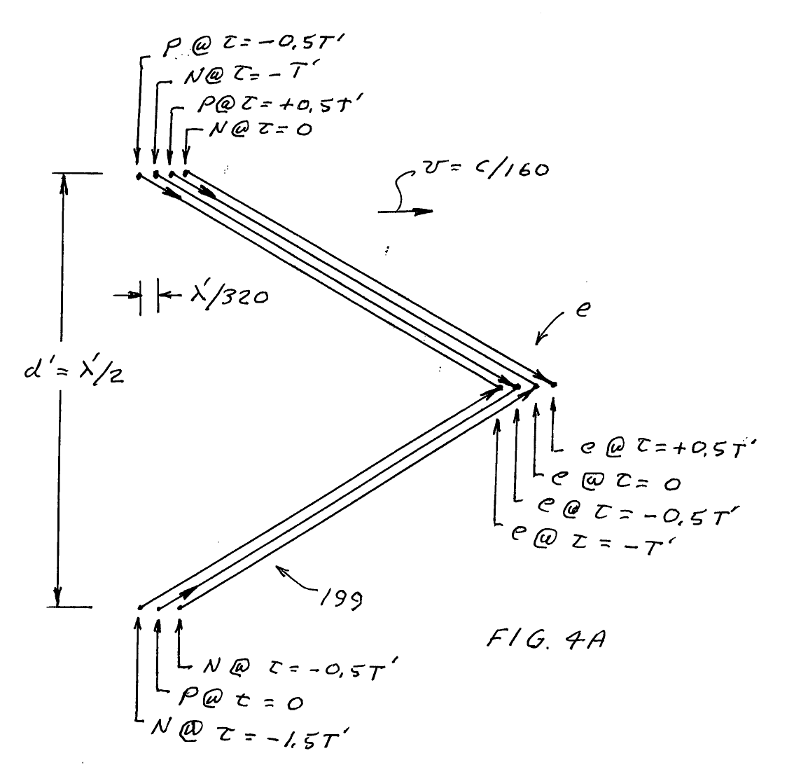

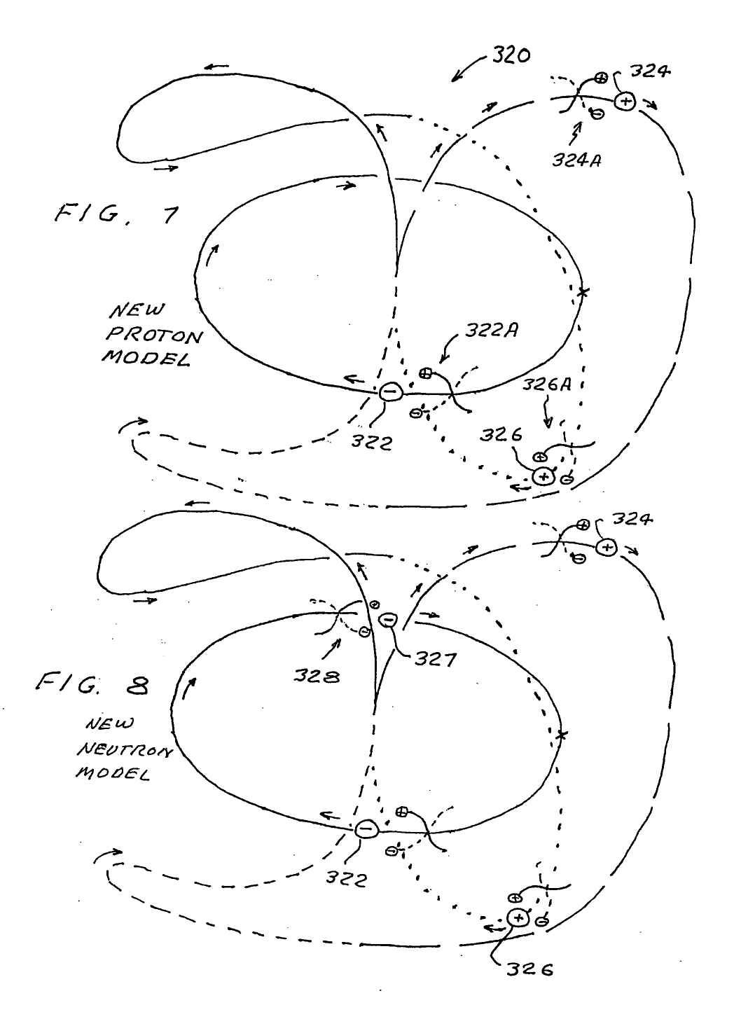

FIG. 11 is a suggested model of an alpha particle (a helium nucleus). This is an extremely stable thing. Often, when large nuclei brake apart, out comes an alpha particle. Its preferred configuration in the Ross Model is very similar to the configuration of the electron, the positron, the proton and the anti-proton. Four protons circle equally spaced in a ring as shown in FIG. 11. Two electrons orbit the ring in synchronization with the orbit of the four protons. The helium nucleus needs fewer neutrinos and gamma rays to drive the protons and electrons than are required in both the tritium nucleus and the deuterium nucleus, so when the nuclei of deuterium and tritium fuse the unneeded neutrinos and gamma rays are released (as heat energy) along with the extra neutron (i.e., a proton plus a close in electron). The reader should take notice that the proposed model of the helium nucleus suggests a good logical reason why orbiting atomic electrons in the helium atom do not spiral into the helium nucleus. The two electrons in the nucleus orbiting the path of the four protons shield the protons from the two atomic electrons that orbit the helium nucleus.

Nuclei larger than the helium nucleus are built up with the same building blocks of the three nuclei shown in FIGS. 8 through 11; i.e., protons, electrons, and neutrino and gamma ray entrons. The reader should keep in mind, however, that according the Ross Model, the basic building blocks are the plus and minus tronnies from which these larger building blocks and in fact everything in the universe is made.

I like this model of the alpha particle for several reasons. Note that the paths of the two electrons are for the most part outside the circle of the four protons. This may result in several alpha particles being attractive to each other at specific separations. At distances of a few nuclear dimensions, alpha particles are certainly repulsive to each other. However, there may be a net attractive force between alpha particles when they are close together. Thus it should be easy to make nuclei of many atoms merely by combining alpha particles. Most of the smaller chemicals in the periodic table are believed to have about the same number of neutrons as protons. According to preferred embodiments of the Ross Model, this means that in the nucleus there are about two protons for each electron; i.e., the same proportion as in the alpha particle. My guess is that in larger atoms many alpha particles exist in the nucleus as alpha particles and they are attractive to each other at nuclear dimensions. As the atoms become bigger a few extra electrons are sprinkled in as extra glue. In addition to alpha particles and electrons, protons (and perhaps some positrons) can be fitted in to fill out the periodic table. The main point is here that we do not need any kind of strong force or weak force to hold nuclei together. All we need is the Coulomb force.

Uncertainty Principal

Heisenberg's Uncertainty Principal enjoys wide support by modern scientists. Therefore, I am naturally reluctant to say it is wrong. I do suggest that scientists may want to think about its application in light of the Ross Model of the Universe and the existence (if I am right) of tronnies that are the building blocks of everything in the universe. For example, if an electron is comprised of three tronnies held together in dynamic equilibrium in their “triple tronnie twirl” as shown in FIG. 4, and if its energy (above its rest mass) is provided by entrons, then we could think of the electron as comprising its trapped entrons. These trapped entrons provide the electron with its velocity and thus its momentum. They also help create uncertainty as to the location of the electron. Since higher energy entrons correspond to smaller entrons, there probably is some relationship between momentum of the electron and the position of the electron. What I'm saying here is that I, like a great many other people, do not fully understand the uncertainty principal, but it may be that it is not basically inconsistent with the Ross Model. If it turns out to be inconsistent with the Ross Model, we will have to see what that means. I would like to prove that the uncertainty principal is incorrect.

Heat and Temperature

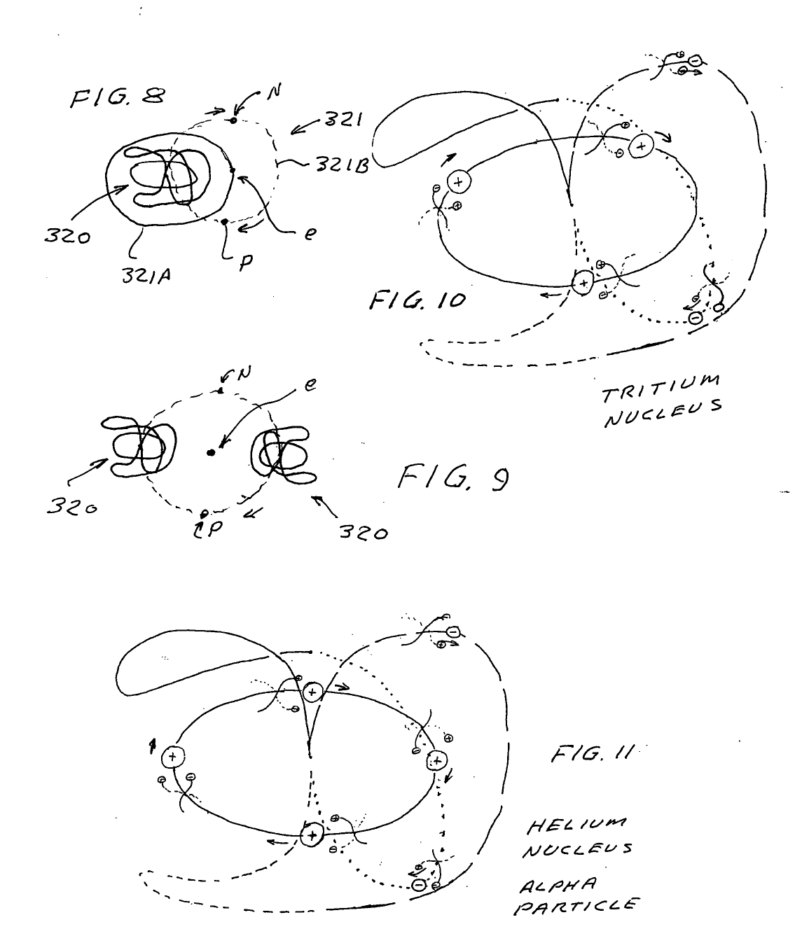

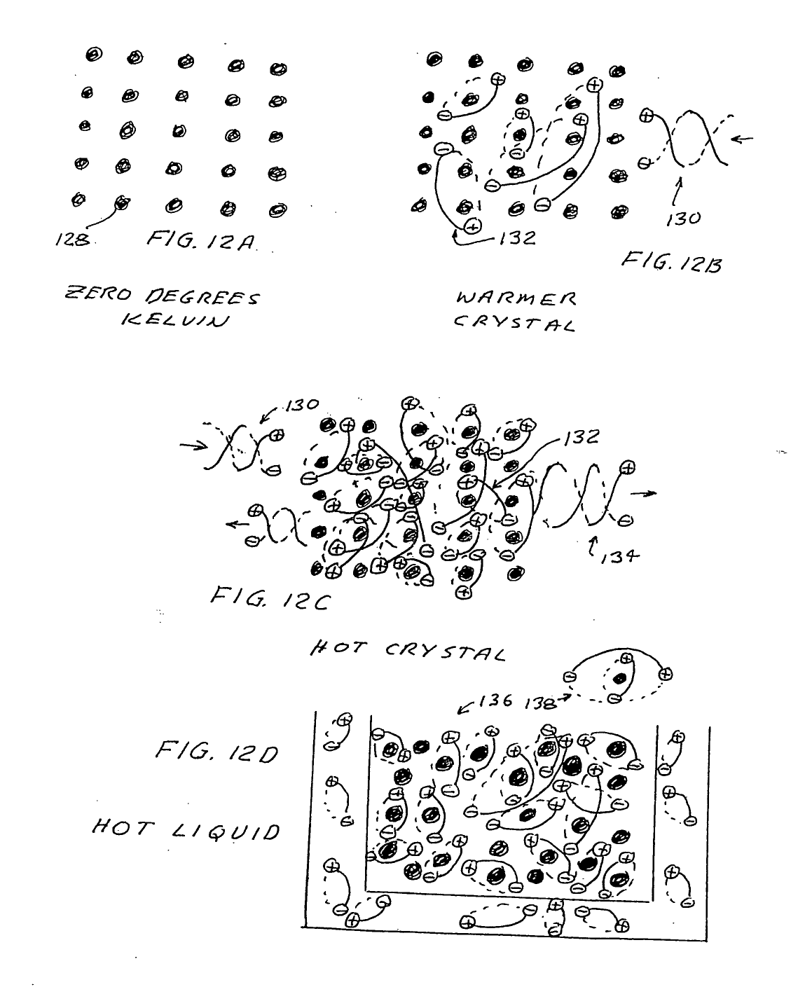

In this embodiment heat and temperature, of a solid, liquid or gas, are expressions of entrons (or tronnie pairs) which have been captured and are temporarily located in the solid liquid or gas. According to this model, all atoms and molecules naturally include a number of tronnie pairs (entrons of neutrinos, gamma rays and other photons) that help define the basic atom or molecule in its natural unheated state (i.e., its absolute zero temperature state). FIG. 12A depicts the atoms 128 of a solid crystal at zero degrees Kelvin. The atoms of this crystal comprise many entrons, but these entrons are part of the make-up of the crystal and there is no force within the crystal structure encouraging them to leave, even at a temperature of absolute zero. However, the crystal can accommodate a great many additional entrons, and if it is placed in an environment warmer than absolute zero, entrons will enter the crystal as indicated at 130 in FIG. 12B and may remain as shown at 132. The more entrons that enter through radiation or conduction, the warmer the crystal becomes. Some entrons may also leave, but there will be a net inflow until the crystal becomes in equilibrium with its environment. FIG. 12C depicts a hot crystal with entrons entering 130 and entrons leaving 134 and many remaining temporally trapped 132. Entrons may retain their entering frequencies inside the crystal or as the result of interactions inside the crystals with other entrons that are part of the atoms or with other entrons, they may have their frequencies increased or decreased. If entrons are continuously added to the solid crystal faster than they are released the number of entrons in the crystal will grow and the entrons will become more and more crowded. (I speculate that the four tronnies of two entrons can combine and when they do the result is a new entron with a frequency equal to the sum of the frequencies of the original two entrons and another entron with a frequency equal to the difference between the frequencies of the original two entrons. Again this is just a guess.) This crowding will cause the crystal structure to expand and eventually disruptive forces of all of these entrons will overcome the forces holding the atoms together in their crystal structure. The crystal may melt as depicted in FIG. 12D. The atoms of the crystal move about more or less randomly as indicated at 136 but Coulomb forces continue to provide a net attraction between the atoms. However, occasionally entrons circling an atom will produce net repulsive forces to cause atoms to evaporate and leave the melted crystal as shown at 138 taking entrons along. Continued heating of the melted crystal will put more and more entrons into the liquid. This has the effect of forcing the entrons into smaller and smaller circles (i.e., higher and higher frequency entrons) and as a result the entrons leaving as photons of thermal radiation have on the average shorter wavelengths. Also, the shorter diameter circles tend to cause the entrons to circle individual atoms. (In a molecular fluid such as water the entrons will tend to circle molecules or small groups of molecules.) This reduces the attraction between the atoms in the fluid and more and more of them will become disassociated from the liquid, i.e., they evaporate. FIG. 12E shows all of the atoms of the original crystal evaporated and completely filling the container as vapor. Each atom is encircled by a number of entrons producing a vapor of atoms and captured entrons and the atoms (with their associated entrons) repel each other and the container creating a pressure in the container. Adding more entrons to the vapor in the form of radiation or convection through the container will increase the number of entrons encircling each atom. Entrons travel from one atom to another and to and from the walls of the container producing a substantial equilibrium among the atoms in the vapor. The temperature is a measure of the number of entrons per atom throughout the process of the heating of the crystal from its absolute zero state to its hot vapor state.

Magnetism

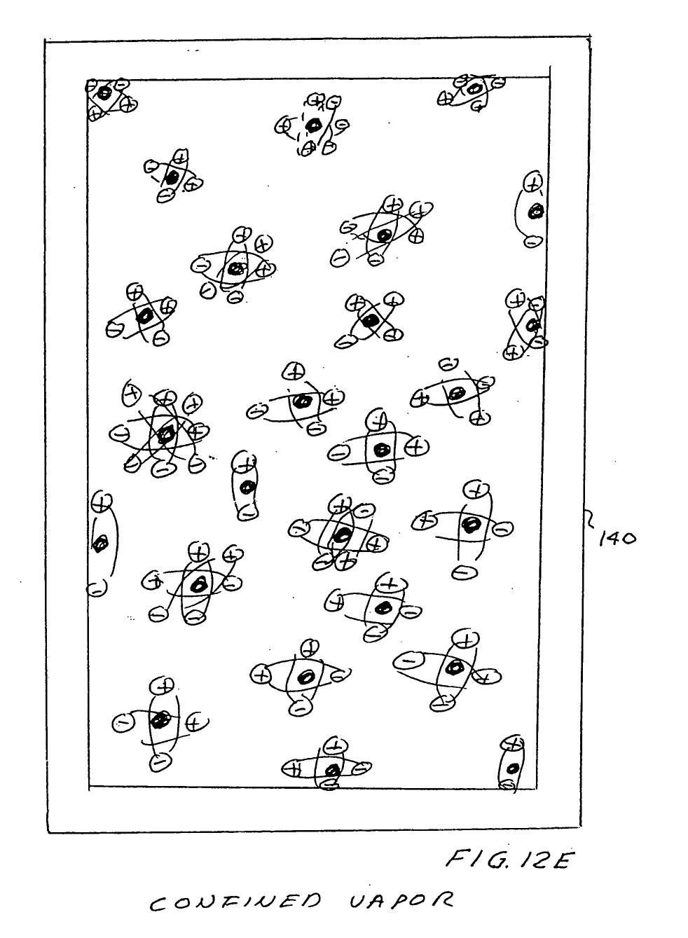

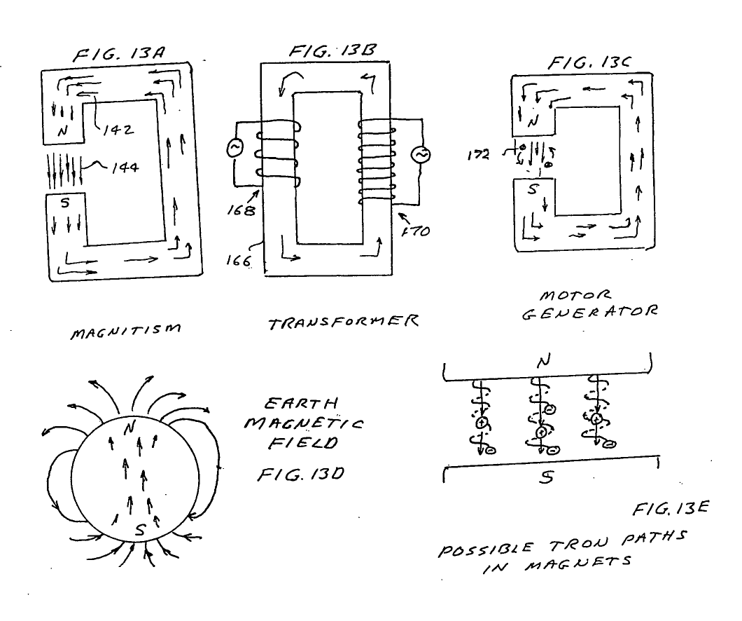

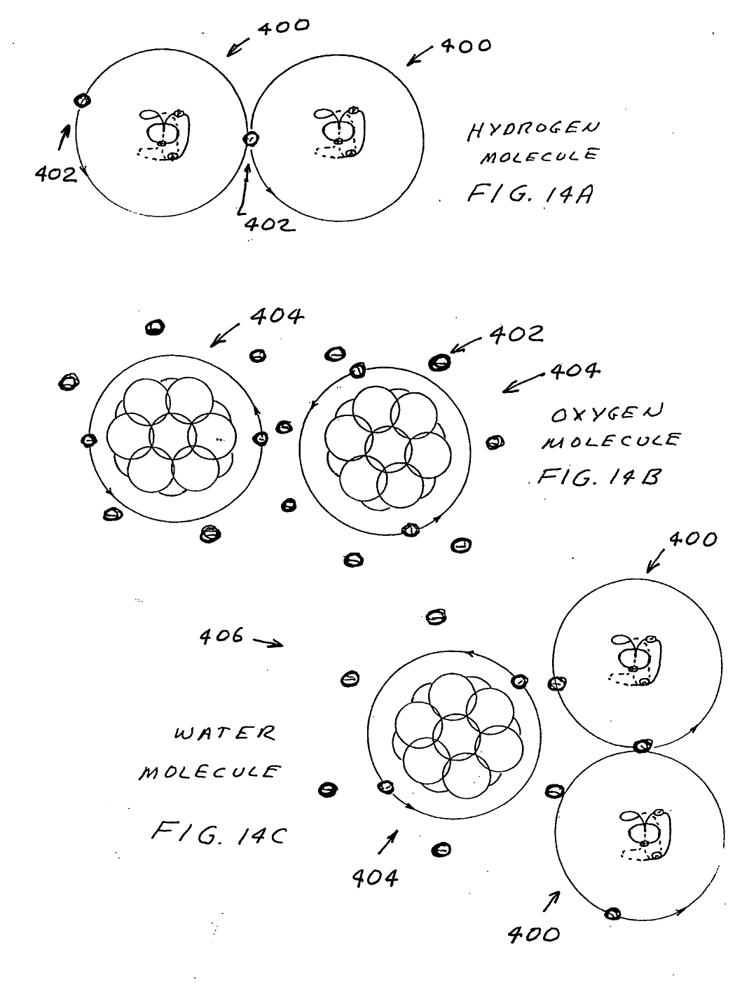

As indicated in the previous section, all solids above absolute temperature have a lot of captured tronnies. These tronnies normally come in as entrons through conduction or radiation and tend to remain as entrons within the solid. However, a tronnie does not have to be paired up. What is important is that it be free to travel at the speed of light or greater. If a tronnie slows down it faces an infinite Coulomb force from immediately behind itself. The tronnie typically likes to be paired up because that allows the to go at a speed greater than the speed of light in a circle with its partner pulling him through his own force field at points half-way around the circle as shown at 86A in FIG. 2. However, if conditions are right the tronnie is just as happy making longer loops so long as the tronnie can do it at the speed of light or greater. This is what I believe happens in a permanent magnetic as shown in FIG. 13A. Here tronnies 142 loop around the magnet moving at the speed of light. They can continue across gaps as shown at 144 in this horse shoe magnetic. If this were a bar magnetic the tronnies would exit the bar at one pole, loop around on the outside and enter at the other pole. Magnets can be created with materials such as iron and a current carrying coil as is well known. I have not figured out which tronnie takes the route shown by arrows 142 and 144 in FIG. 13A. I think it is the positive tronnies in most magnets and the negative tronnies orbit around the positive tronnies in a helical pattern as shown in FIG. 13E. FIG. 13B shows a transformer. Here electrons flow in four loops in primary coil 168 around iron core 166. The fields set up by the orbiting electrons and minus tronnies pushed along by the electrons allow plus tronnies to flow freely around iron core 166 at speeds equal to or greater than the speed of light. If the current in primary winding 168 is alternating then the direction of the tronnie flow will alternate accordingly. This will produce an alternating flow of negative tronnies around core 166 that will create a current in loop 170.

FIG. 13D depicts the earth's magnetic field. I believe that circulating metals in the earth's interior create conditions under which tronnies are able to travel through and around the earth as shown in the figure. Since their speeds are in the range of the speed of light or greater, the round trip is probably less than a second. FIG. 13C represents motors and generators, which involves conductors rotating in magnetic fields. I have not figured out how electricity is generated or how the flowing tronnies and electrons turn the motor shaft. I think it may works like this: As a conductor 172 passes through the magnetic field (i.e., the streaming tronnies) shown at 172 in FIG. 13C plus tronnies in the conductor are forced in one direction and minus tronnies are forced in the opposite direction. When the conductor loops around and passes back through the streaming tronnies in the opposite direction then the tronnies in the conductor are forced in directions opposite those of the first pass. Another possibility is that the tronnies shown in FIG. 13E are captured into the conductor as it makes one pass through the streaming tronnies and exits the conductor into the stream when the conductor passes back through the stream in the opposite direction. Somehow, I think, entrons are generated in a conductor and these entrons are captured on electrons giving them their energy (voltage).

Chemical Energy

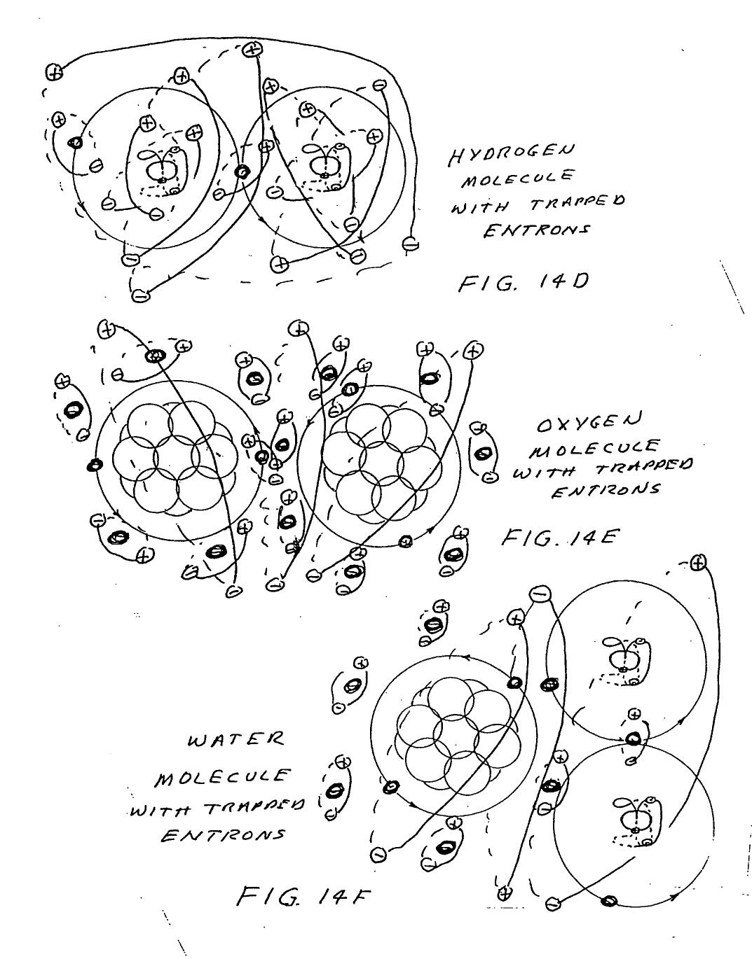

FIG. 14A depicts a hydrogen molecule which is two hydrogen atoms 400 sharing electrons 402. FIG. 14B shows an oxygen molecule, which are two oxygen atoms each with six electrons in their outer shells and sharing two electrons to complete the eight electrons desired shell. FIG. 14C depicts a water molecule H₂O 406. FIG. 14D depicts a hydrogen molecule like that shown in FIG. 14A but with a large number of trapped entrons. FIG. 14E shows an oxygen molecule also with a large number of trapped entrons. These numbers of entrons in the hydrogen and the oxygen is assumed to represent equilibrium states at a particular temperature. FIG. 14F depicts a water molecule at the same temperature as the hydrogen and oxygen temperatures, but according to the drawings the water molecule has around it many fewer entrons than the entrons in the hydrogen molecule plus one half of the entrons in the oxygen molecule. This example is suppose to show that when hydrogen burns in oxygen to form water the energy produced is excess entrons which are released in the process in the form of photons. The point here is that in all exothermic reaction the heat released is excess entrons, usually as photons. In many reactions heat must be added to make them go. In these cases the natural state of the product needs more entrons than the constituents at the same temperature.

Fusion and Fission

FIGS. 9 through 11 are representations of the nuclei of deuterium, tritium and helium 4. According to the Ross Model a helium nucleus is comprises of fewer neutrino and gamma ray entrons than are comprised in the nuclei of tritium and deuterium combined. Therefore, when tritium and deuterium fuse the excess entrons are released as photons, in this case very high-energy gamma photons plus some neutrinos. In fission I believe uranium 236 (U-235 plus a neutron) has more entrons (very high-energy trapped photons) associated with it than the fission products resulting from the fission. So that, again, heat energy is released in the form of high-energy photons along with two or three excess neutrons and two atomic fission products.

Thermoelectric Effects

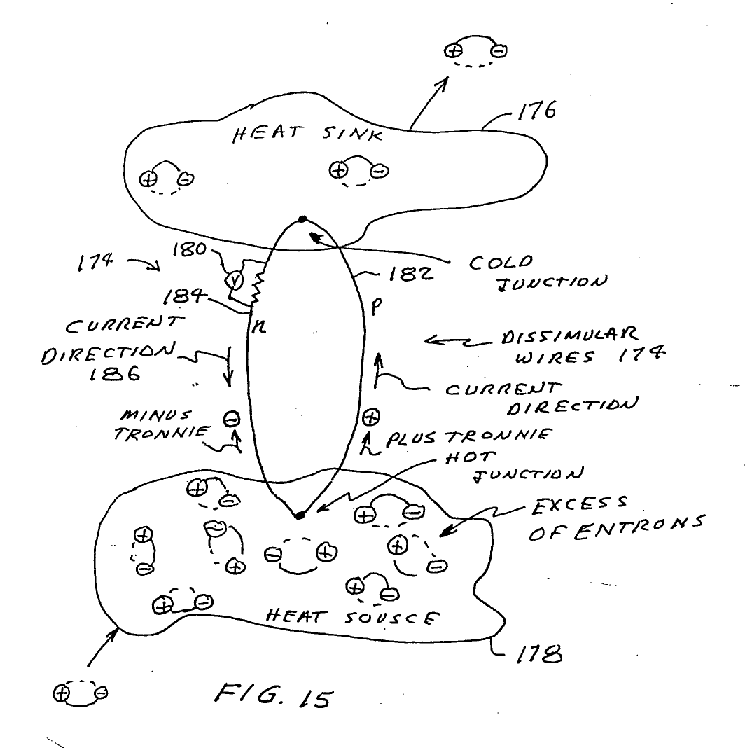

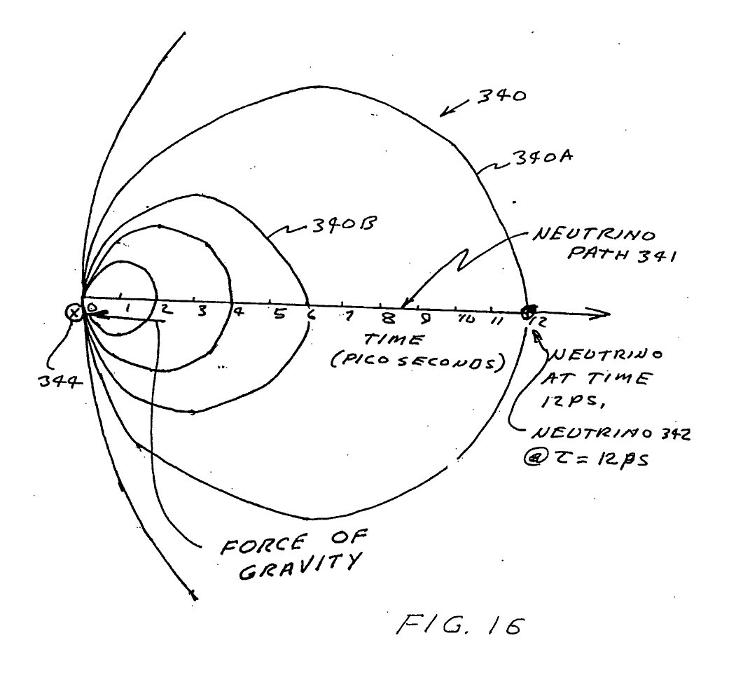

Electric energy can be generated directly from a temperature difference by reason of the thermoelectric effects. FIG. 15 depicts a thermocouple made from dissimilar wires 174 with one junction at cold heat sink 176 and the other junction in hot heat source 178. Voltmeter 180 measures the potential difference generated. As indicated the heat source contains many more tronnies than the heat sink. The larger number of entrons at the hot junction gives the electrons at the hot junction additional energy allowing them to travel up the n-leg to the p-leg at the cold junction where the electrons give up their entrons. Once on the p-leg the electrons flow down the p-leg to fill holes created in the p-leg by the flow of the electrons up the n-leg.

Gravity

In prior art models of the universe, there is speculation that a particle called the “graviton” is the carrier of gravity although no one has ever seen a graviton despite extensive searches for them. The existence of neutrinos is well accepted in prior art theories with about 150 million of them passing through every square centimeter of earth each second. In all references to them that I have seen there is no indication that neutrinos carry any charge or charges or has any relationship to gravity. There is some question in the prior art as to whether neutrinos have mass. According to the Ross Model, the neutrino is nothing more than a high frequency, short wave length photon, as described above. It like all photons has no net charge but carries two equal and opposite charges. Like all photons the neutrino is comprised of an entron made up of a circulating pair of tronnies that travel through space. The width of the entron (i.e., the maximum separation of the two tronnies is much smaller than atomic dimensions so it passes right through almost all atoms in its path and is only very rarely stopped even when passing through bodies as large as the earth. FIG. 16 shows Coulomb fields 340 produced by a neutrino 342 from the sun passing through the earth. It is traveling through the earth at the speed of light or a substantial fraction of the speed of light so that in 12 pico-seconds it would travel:
D=(12×10⁻¹² s)(3×10⁸ m/s)=3.6 mm,
or somewhat less than 3.6 mm.

It like all photons is pushed by its own Coulomb force fields as indicated at 342 in FIG. 16. Circle 340A represents a cross section of the fields at t=12 ps that emanated from neutrino 342 at t=6 ps. Circle 340B is the field at t=6 ps that emanated from neutrino at t=3 ps. The reader should understand that the fields from all points along the path of neutrino 342 define spheres that intersect the path 341 just behind neutrino 342. Of these, only field 340A that emanated from the neutrino at time 6 ps is shown.

The new idea here is the effect of these fields on a charged element (such as an electron or the constituent parts of an electron [i.e., tronnies]) that is substantially stationary in the matter through which the neutrino is passing. The first thing to realize is that tronnies (such as a plus tronnie 344) near the path of a neutrino (as shown in FIG. 16) never feel effects of the neutrino until after the neutrino passes it. This is obvious from our earlier discussions of photons and from FIG. 16. However, after the neutrino 342 passes plus tronnie 344, plus tronnie 344 does feel the repulsive Coulomb forces emanating from the plus tronnie part of neutrino 342 and is repelled by it. In fact at every instant along the path 341 of neutrino 342 a Coulomb wave is emitted that repels tronnie 344 according to the physics of the Coulomb inverse square law. Thus, the matter in which tronnie 344 is trapped feels a force pushing it toward the sun (i.e., the origin of the neutrino). This is the source of the sun's gravity. Its gravity is carried by the neutrino from the sun to the earth. Thus, neutrinos and other mass penetrating photons (if there are any) not gravitons are the carriers of gravity!

“OK”, a reader might ask, “Where does the earth get its gravity attracting me to its surface?” I suspect that a significant portion of neutrinos from the sun are scattered from protons and maybe electrons in the earth and some are absorbed then later released in all directions. So (except for the neutrinos passing through the earth from the sun and other neutrino sources) the total of the matter penetrating photons coming out from the earth is relatively uniform in all directions. These matter-penetrating photons apply a reverse force to the charged elements inside our bodies, pushing us toward the center of the earth. I believe neutrinos are emitted from protons and possibly electrons inside nuclei and are absorbed by these protons and possibly electrons. They may also be captured and released from electrons outside nuclei and maybe electrons outside atoms. Thus, in a mass like the earth an equilibrium will be reached in which the number of neutrinos absorbed in all of the protons and electrons (and also neutrons if you want think of them as different from a proton plus an electron) in the earth reaches a constant level which means that the earth is also a major source of neutrinos that are emitted in all directions. This source is (according to this feature of the Ross Model) the carrier of the earth's gravity.

Black Holes

If neutrinos are the carriers of gravity, then black holes must emit an awful lot of them. My suspicion is that much of the matter sucked into black holes is destroyed by nuclear processes inside the black holes, releasing their neutrinos to provide the black hole's gravity to suck in more matter. Remember every proton comprises three neutrinos. So if protons are destroyed inside a black hole they provide a tremendous source of neutrinos. Thus, the only thing getting out of the black hole is neutrinos that are then the agent for pushing more matter into the hole. The black holes are also sucking in the hydrogen dispersed in interstellar space and releasing its neutrinos to go out and get more matter.

Receding Galaxies

So, a reader might ask. Why are galaxies moving apart. An answer may be that a tremendous number of hydrogen atoms and molecules are distributed sparsely in the inter-galactic space. These hydrogen atoms and molecules would absorb a percentage of neutrinos emitted from the galaxies including the black holes in the galaxies and then re-emit the neutrinos in random directions; thus, reducing the effectiveness of these neutrinos as gravity carriers from their source. However, longer wavelength photons from each galaxy do penetrate the intergalactic space (obviously because we can see them), but these are absorbed near the surfaces of the galaxies applying a repulsive force causing most galaxies to recede from each other.

The Speed of Light and Special Relativity

Michelson and Morley in 1887 determined that the measured speed of light on earth was constant in all directions even though the earth was moving at a significant fraction of the speed of light through the universe. With this information Albert Einstein based his Special Theory of Relativity of the assumption that, “The speed of light in a vacuum has the same value c in all directions and in all inertial reference frames.” Based on this assumption, he convinced the world that time must slow down if you go fast and that simultaneous events in a first reference are not simultaneous in a second reference frame moving relative to the first reference frame. More recently experiments have shown that the speed of light is independent of the speed of the source of the light. This has been taken to support Einstein's assumption that the vacuum speed of light is always constant at c. This in not the case.

Photons in a light beam slow down when passing through a Coulombic reference frame (such as a laboratory where light speed is being measured) moving opposite the beam. And they speed up when the reference frame is moving in the same direction of the beam. Photons push themselves through a Coulombic reference frame in the same manner that a fish pushes himself in a flowing river. The fish's net speed is the sum of his speed and the river's speed. The photon's speed is the sum of c plus the speed of the Coulombic reference frame through which it is traveling. If the frame is moving opposite the photon direction at 0.1c, then the photon speed will be 0.9c. If the frame is moving at 0.2c in the direction of the photon the photon speed will be 1.2c. In both cases scientist in the reference frame will measure the speed of the photon as c, but they will not be measuring the true speed of the photon. Based on this preferred model, time does not slow down when you go fast and things do not get shorter. Simultaneous events are simultaneous in all reference frames. When an astronaut returns to earth he and his twin brother can have their next birthday party together at the same time. Based on the Ross Model, a photon does not care about the speed of the matter from which it was emitted. The photon pushes itself at the speed of light in each Coulombic reference frame through which it travels. However, its net speed is moderated by the speed of the Coulombic reference frame as described above.

The End of the Universe

It may be that when a sufficient portion of the free hydrogen in the space between galaxies has been sucked into the black holes that apparently exists in the center of large galaxies, the neutrinos from the black holes of the separate galaxies will begin to pull all galaxies together into one gigantic black hole marking the end of our universe.

The Beginning of the Next Universe

When all or substantially all of the matter of our present universe has been sucked into this gigantic black hole, the universe will be left with only the black hole made up of very hot neutrons (actually protons [each of which is an electron and two positrons], an equal number of electrons and a tremendous number of trapped photons that makes the black hole the hottest hell imaginable) and neutrinos which have traveled out radially from the black hole. As long as matter is being sucked into the black hole, photons other than neutrinos trying to escape will be absorbed or scattered by the incoming matter. Any photons that in not going out radially will be overtaken by neutrinos and sucked back into the black hole keeping it as hot as hell. When there is no more matter coming into the black hole, then longer wavelength light can get out as long is it is heading in a radial direction. This escape of photons could produce a cooling of the black hole permitting neutrinos coming from the center of the black hole to pull the contents of the black hole into a softball size volume at which time the positrons and electrons making up the matter of the black hole are compressed together annihilating each other releasing the annihilation gamma rays and the neutrinos that had been the source of the velocity of the electrons and positrons in the neutrons. This will be the next big bang!

Multiple Universes

We could therefore speculate that several universes have preceded ours. And that other universes will follow ours after all the black holes in our universe have collapsed into our universe's deepest black hole. Maybe the grand plan is for each succeeding universe to be born in a big bang expand for about 50 billion years, contract for about 50 billion years and then provide in a new big bang the set of mass-less, volume-less charged particles for the next universe. So our universe may be the 17^{th} in the universe in this series of universes or maybe the 17 thousandth universe in the series. Who knows?

String Theory

I do not understand string theory; however, I do understand that many very smart people believe in it because it produces results that are consistent with experimental results. The problem is that the theory is too complicated. It requires several additional dimensions in addition to the three spatial and one time dimensions with which we are familiar. I cannot believe that God designing the universe would incorporate ten or more dimensions. I think He would do it as simply as possible. It may be that some of the features of the Ross Model are consistent with features of the string theory. Maybe the electron model shown in FIG. 6 is one of the extra dimension and the proton model shown in FIG. 9 is another and maybe the alpha particle shown in FIG. 11C is another.

Symmetry

This model of the universe provides perfect symmetry, an equal number of plus and minus tronnies, of which the entire universe is constructed. If a plus tronnie were to combine with a minus tronnie, both would vanish into nothingness with nothing left over, no mass, no energy, no nothing. Thus, we can imagine that since we have an equal number of minus tronnies and plus tronnies and since each combination of plus and minus tronnies equals nothing; the universe could come from nothing. I do not have a suggestion as to how this could be done. That is something we need to work on.

Model is Evolving and Getting Better

The reader should understand that this theory is not fully developed. It has been evolving for more than four years. It started with an attempt to show that protons could be made from positrons and electrons. A five electron model was proposed (three positrons and two electron with the electrons orbiting one of the positrons fast enough that their velocity very close to c would increase their mass by about 900 times. Later on I developed the idea that electrons must be made from photons. This seemed likely since that is how electrons are made in pair production. What was added was the notion that both photons and electrons are made from charged things, called tronnies. Since tronnies have no mass, they could go faster than the speed of light; therefore, they could be pushed by their own Coulomb force field. My first attempt at an electron model had one tronnie in the center with two opposite tronnies orbiting. Once I had an electron model made from the constituents of photons, I went to work trying to make everything out of tronnies. I developed models for heat, electricity, magnetism. I at this point convinced myself that everything in the universe was made from tronnies. My first electron model was not very satisfying because nothing seemed to keep it from collapsing on itself. Also, it was hard to see the central tronnie going as fast as the speed of light. Then I developed the tripple tronnie twirl and this model seemed perfect. It had spin. It had to have a non-zero volume since the outer tronnies had to pass through the circlular path of the central tronnie. Not only that, it seemed to provide a good model for the proton especially if I was correct that captured tronnie pairs provided electrons with their excess energy (and mass). Having gone this far, maybe I really could show the possibility of everything in the universe being made from tronnies and all forces in the universe being derived from tronnies. The most difficult was gravity. The breakthrough was my realization that neutrinos might be photons and (like photons) be comprised of two opposite charges. This is almost too simple. I had tried for almost three years to describe gravity in terms of the Coulomb force. My calculations would not work out. I could never come up with an inverse square relationship. Now, however, could neutrinos carry the gravitational force? Neutrino flux is huge and it decreases from its source as the inverse square. I had earlier showed that a photon (or a tronnie for that matter) traveling at the speed of light exerts no force in front of itself pushing toward its source. However, I then realized that it exerts plenty of force behind itself. And almost all neutrinos form the sun pass completely through the earth, billions and billions and billions of them each second, all pushing the earth back from wince the neutrinos came. This must be gravity! I think I got it! I think I got it!

In this application I first describe two additional improvements in my model. The first of my last two improvements has been the improved description of the photon with the entron carrying the photon energy. This allowed me to correlate the photon's energy with the entron's integrated Coulomb forces. And the last of these two improvements has been my realization that the speed of light slows down or speeds up when it passes through a Coulombic force field. So its speed measured by people and equipment moving with the Coulombic force field is always constant. Thus, the vacuum speed of light is not constant. This meant that most of the complicated features of the Special Theory of Relativity are wrong. Time is absolute and is the same in all reference frames no matter how fast they are moving relatively to each other. Things do not shrink or stretch when you go fast. They stay the same size.

Correctness of Models

The models presented in this specification (including the models of the photon, the electron, the proton and the model of atomic nuclei presented above) constitute major departures from the most widely accepted theories explaining the makeup of nuclear particles. The reader should understand that the models presented herein are evolving. Some are going to be proven incorrect in all likelihood. I expect to develop better models. I am sure others will also if it turns out that I am generally on the right track with the concepts described in this specification. If all of my ideas are not correct, I will be in good company. Newton and Maxwell did not get it right in every situation. If these models are anywhere close to being correct all physics books written during the past 20 years will have to be substantially revised. I recognize that many of the smartest people in the world have devoted their lives to efforts directed at explaining the makeup of these nuclear particles. I have described models in the very long shot belief that they might be correct or that they are close to correct. I have presented these models as patent applications for three reasons: (1) I am a patent attorney (a long time ago I used to be a nuclear engineer) and I am familiar with patent applications as a technique for publishing discoveries, (2) a patent application is at least initially kept secret and can be abandoned, or corrected in continuations-in-part so if I learn soon that I has made foolish mistakes, I can perhaps minimize my embarrassment and (3) in the unlikely event I am right, I would like to have some control over the applications of my discoveries. However, all of my current and past clients will have a royalty-free right to practice (in their current business activities or in any current or past anticipated research and development) under any resulting patent.

### Testing the Models

Many processes are available for utilizing, testing and evaluating the models described herein. One process is for a person experienced in modern nuclear physics to evaluate the models as they have been presented in this specification. This can easily be accomplished with a hand calculator.

### Computer Models

A more sophisticated model would be to utilize a digital computer model incorporating one or more of the models. It should be fairly simple to model the tronnies, the entrons, the positrons the negatrons the protons and neutrons in the electron and proton models and determine if they are stable. If I am right, these models will show that the electron and proton and their antiparticles should be enormously stable except when opposites meet. By making the computer model a little more complicated, it should be feasible to determine how hard it would be to make a proton using the technique described above for doing that. Perhaps then the computer model could be extended to predict the formation of protons in the models during the process that followed the big bang. Once the electron, proton and neutron have been modeled on a digital computer it would be relatively simple to create similar computer models to examine the Nuclear Models. After these models are created investigations could be preformed to determine if a technique can be developed to breakup the proton and release its energy. If this could be done economically, we would have what may be the most important invention since the beginning of civilization. The models of current flow described herein should be extremely important if they are correct in understanding current flow in everything from integrated circuits to electric power transmission circuits. The techniques herein should also be very valuable in the understanding and design of communication systems from radio, microwave to fiber optics. In each case a heretofore unknown thing, the tronnie, is the workhorse in making these systems work. Now we should really understand why these systems work and as a result maybe make them work better.

### Nuclear Tests and Experiments

If computer modeling shows that the models are correct or that modifications or derivations of the models are correct. A next step is to perform some experiments with particle accelerators to test the models or aspects of the models. It may be that current accelerators do not have the capabilities to properly investigate the models. If so and if the models are shown to be possibly correct then perhaps accelerators can be built to properly test the models. Actually, since the filing of the parent to this Application, Applicant has read that already experiments have been conducted in which positrons and negatrons were fired at each other each with high energy and the result was protons! Also, as referred to above, experiments have been reported in which the annihilation of protons and anti-protons produced electrons and positrons. We have known for many years that electrons and positrons can be produced form photons and that the annihilation of electrons and positrons produce photons. All of these experiments support the models described above.

### No Quarks, No Special Weak Force, No Strong Force and No Separate Gravitational Force

This model shows how nuclei can be held together by Coulomb forces which unquestionably exist. Therefore, there is no need to invent nuclear forces for which there is no proof of existence such as the special weak nuclear force and the strong nuclear force. Also, since the above model shows how protons and neutrons can be held together in the nuclei of atoms there is no need to invent quarks for which there is no good experimental evidence.

While preferred embodiments of the present invention are described above, the reader should not construe the present invention as limited by the above description. In fact persons skilled in nuclear physics will envision many other possible variations within the scope of the present invention. The reader may note that the proton shown in FIG. 7 and the particles shown in FIGS. 9-11 all comprise negatrons and positrons zooming around in circles and loops. These circling and looping charges may encourage tronnies near the particles to loop through and around the looping electrons creating tiny electric magnets. These loops could extend out of one particle into and through another; thereby helping to hold nuclei together. This may also be happening on an atomic scale helping to hold groups of atoms together. These models therefore may be very useful in describing physics issues such as nuclear magnetic resonance and superconductivity. The reader should note that the proton model, unlike the alpha particle seems of have the two positrons on the outer regions of the dynamic structure. This would seem to invite the electron in the hydrogen atom to come crashing into the nucleus. However, this model can also be viewed as two positron orbiting in a common path on a rotating plane with the electron offset and extending out from the rotating plane and rotating with it. It may be that the atomic electron does not venture too close to the proton because to do so it would have to come too close to this nuclear electron as it swings around billions of times per second. Also, it is certainly likely that someone who knows a lot more than me about proton experimental data will propose the true model of it based on my basic concept of everything in the universe (including protons) being made from nothing but tronnies. I welcome the help. Accordingly, the reader is requested to determine the scope of the invention by the appended claims and their legal equivalents and not by the above examples.

1) A process for modeling elements of the universe utilizing in models negatively charged tronnies, each having zero mass and a negative charge of about 1.9×10⁻¹⁹ Coulomb and positively charged tronnies, each having zero mass and a positive charge of about 1.9×10⁻¹⁹ Coulomb, said process comprising:
A) assigning an electric force field to each plus tronnie which expands out spherically from each of said plus tronnie with a velocity equal to a speed of light and produces an attractive Coulomb force on minus tronnies and a repulsive Coulomb force on plus tronnies,
B) assigning an electric force field to each minus tronnie which expands out spherically from each of said minus tronnie with a velocity equal to a speed of light and produces an attractive Coulomb force on plus trons and a repulsive Coulomb force on minus tronnies,
C) allowing some or all or said tronnies to be repulsed by their own force fields and to be repulsed and attracted by force fields from other tronnies so as to attain velocities equal to and greater than the vacuum speed of light, and
D) using said plus tronnies and said minus tronnies to model elements of the universe.

2) The process of claim 1 wherein everything in the universe is comprised of only said plus and minus tronnies.

3) The process of claim 1 wherein an entron is modeled as being comprised of one plus tronnie and one minus tronnie traveling together with each tronnie being pushed by its own force field and attracted by the force field of the other tronnie.

4) The process of claim 1 wherein a photon is modeled as being comprised of one plus tronnie and one minus tronnie traveling together with each tronnie being pushed by its own force field and attracted by the force field of the other tronnie.

5) The process of claim 1 wherein a photon is modeled as being comprised of one entron.

6) The process of claim 1 wherein a neutrino is modeled as being comprised of a plus tronnie and a minus tronnie.

7) The process of claim 1 wherein a negatron is modeled as being comprised of a plus tronnie and two minus tronnies.

8) The process of claim 1 wherein a positron is modeled as being comprised of a minus tronnie and two plus tronnies.

9) The process of claim 1 wherein a proton is modeled as being comprised of a negatron and two positrons plus at least three neutrino entrons.

10) The process of claim 1 wherein a nucleus of an atom is modeled as being comprised of protons and electrons and gamma ray entrons.

11) The process of claim 1 wherein a magnetic force is modeled as being produced by the flow of tronnies into and out of magnetic material.

12) The process of claim 18 wherein the magnetic material is the core of the earth and the tronnies are modeled as flowing into and out of the earth at locations near the north and south poles.

13) The process of claim 1 wherein the entire universe and its evolution before and after the big bang is model using only plus and minus tronnies as building blocks.

14) The process of claim 1 wherein neutrinos are modeled as high-energy photons.

15) The process of claim 21 wherein the neutrino is modeled as a carrier of gravitational force.
